(19) United States
(12) Patent Application Publication
(10) Pub. No.: US 2006/0149641 A1
(43) Pub. Date: Jul. 6, 2006

(54) Method and apparatus for relational linking based upon customer activities

(75) Inventors: Michael R. Loeb, Darien, CT (US); Jonathan E. Ellenthal, Wilton, CT (US); Shane O'Neill, Wallingford, CT (US); Jeffrey Fleishman, Arlington, VA (US); Ronald Clarke, Ellicott City, MD (US)

Correspondence Address: Daniel H. Golub, 1701 Market Street, Philadelphia, PA, 19107, US

(73) Assignee: Synapse Inc., Stamford, CT (US)

(21) Appl. No.: 11/261,431

(22) Filed: Oct. 28, 2005

Related U.S. Application Data
(63) Continuation of application No. 09/457,237, filed on Dec. 8, 1999, now abandoned.

(51) Int. Cl. G06Q 30/00

(52) U.S. Cl. 705/26

(57) ABSTRACT

A reason code and token facilitate linking of a primary and secondary merchant to allow the secondary merchant to make an offer to a customer of the first merchant. The website linking system has a reason code, a token, a schema defining information to be passed from a first website, and a validator. The token is constructed to indicate a particular customer of the first website. The reason code correlates to a specified parameter to be used when making an offer to the customer indicated by the token, and the validator and the token are constructed to indicate the schema is a valid schema to the first website. The linked merchant transaction method involves receiving a reason code from a primary merchant for a customer in response to a transaction between the primary merchant and the customer; providing an offering to the customer based upon the reason code; receiving an acceptance from the customer; and in response to the acceptance, receiving customer identifying information from the primary merchant.

### BACKGROUND OF THE INVENTION

1. Field of the Invention

The present invention relates generally to electronic commerce. More particularly, the invention relates to a method and apparatus for linking a primary and secondary merchant to allow the secondary merchant to make an offer to a customer of the first merchant.

2. Description of the Related Art

Retail merchants recognize that by increasing customer access to their goods or services they will generally recognize an increase in revenues. This is the economic force behind the explosion of ordinary retail merchants launching websites on the internet.

To increase sales over the internet, electronic commerce merchants must first attract increased traffic to their website and ideally, do so inexpensively. There are several approaches which have been used in this regard. In one approach, a “banner ad” is placed on one or more websites of another entity, which will hopefully attract visitors to click on the banner, which links the visited website to the banner placing merchant's website.

Alternatively, websites may have simple hyperlinks on their sites with prompting messages such as “If you liked our site, please visit <<website >> at <<website URL>> for <<some identified subject matter>>.” Banner ads and hyperlinks both require affirmative action on the part of the visitor. Moreover, a lack of familiarity and/or trust regarding the merchant to which the banner ad or hyperlink links may inhibit a visitor from using them.

In other instances, websites may join with other websites in what are referred to as “rings”. Rings tend to have some common focus element or theme under the assumption that a visitor to one of the ring members may also go to the websites of others in the ring because of the commonality. The subject matter focus of rings is often fairly narrow.

In a separate vein, merchants may enter into arrangements with other companies to offer combined packages of goods or services through tie-ins, e.g. buy a particular product, get a second product free. Tie-ins may also be of limited effectiveness, since they are a “shotgun approach” to generating sales and often provides no choice for the customer's selection.

Another way merchants attempt to increase revenues is to induce a customer to make another purchase from them at some later point in time. Reward programs are typically offered by sponsoring companies to promote the sales of their products or services, to induce customers to provide personal data or to answer survey questions. Those participating in reward programs usually receive points or credits that can be accumulated and exchanged for specified merchandise or services.

Frequency programs have also been developed by the travel industry to promote customer loyalty. An example of such a program is a “frequent flyer” program. According to such a program, when a traveler books a flight, a certain amount of “mileage points” is calculated by a formula using the distance of the destination as a parameter.

While reward and frequency programs may increase repeat business and aid customer loyalty, redemptions are not immediately available. Another drawback to reward and frequency programs is their cost because, the program supporting entity may need to outlay significant sums of money to inventory the merchandise and to maintain warehouses, etc.

In another type of program that awards merchandise, the supporting entity does not maintain its own inventory of merchandise. The supporting entity arranges with other suppliers or distributors to fulfill the needs of individuals that are eligible for the rewards. In this situation, an additional layer of merchandise handling is imposed which may cause significant delay in shipment of the merchandise to the individual or even mistakes caused by this additional communication layer.

Thus, a need exists for increasing merchant exposure to customers who are more likely to make a purchase at a particular point in time.

A need also exists for a way to offer an incentive for repeat on-line purchases which reduces the costs associated with administering the incentive program while offering customers the kinds of items they are likely to want, at a time they are likely to want them.

### SUMMARY OF THE INVENTION

The present invention satisfies the existing needs and offers various features and advantages by allowing a secondary merchant to automatically present an offering of products or services to a customer of a primary merchant following a favorable action by the customer (i.e., when the customer is in a “purchasing mood”) cheaply, efficiently and, in an appealing manner. In one embodiment, the offer can be made without any additional action on the part of the customer, beyond the original actions, and the offer can be accepted and completed with minimum burden on the primary merchant. In another embodiment, an application of the principles of the invention allows a primary merchant to reward customer loyalty in a manner which is more immediate than traditional reward programs while minimizing the burden on the primary merchant.

To achieve the advantages and benefits, one aspect of the invention includes a linked merchant transaction method involving receiving a reason code from a primary merchant for a customer in response to an interaction between the primary merchant and the customer, providing an offering to the customer based upon the reason code, receiving an acceptance from the customer, and in response to the acceptance, receiving customer identifying information from the primary merchant.

The above and the description herein will render apparent advantages and features which address the above referenced existing needs. However, those advantages and features are only for representative embodiments, and are presented only to assist in understanding the invention. It should be understood that they are not to be considered limitations on the invention as defined by the claims, or limitations on equivalents to the claims. For instance, some of the advantages are mutually contradictory, in that they cannot be simultaneously present in a single embodiment. Similarly, some advantages are applicable to one aspect of the invention, less applicable to others, or wholly inapplicable to still others. Thus, the features and advantages should not be considered dispositive in determining equivalence. Additional features and advantages of the invention will become apparent in the following description, from the drawings, and from the claims.

### BRIEF DESCRIPTION OF THE DRAWINGS

The accompanying drawings illustrate aspects which assist in understanding the invention. The drawings are incorporated in and constitute a part of this specification.

FIG. 1 illustrates an example system incorporating the invention;

FIGS. 2A-2B illustrate an example primary merchant 100 and secondary merchant 110 from the system of FIG. 1;

FIG. 3A-3B illustrate a schema for collecting information from a primary merchant;

FIG. 4 illustrates the schema of FIGS. 3A-3B as filled out by the primary merchant;

FIG. 5 illustrates the data flow for a commercially suitable rewards system implementing the invention;

FIG. 6 is a flow chart for the operational flow of an example embodiment of the invention;

FIG. 7 illustrates an order form usable in connection with the invention;

FIG. 8 illustrates a generic offer template;

FIG. 9 illustrates an example offer template usable in a rewards program;

FIG. 10 illustrates another example template usable in an alternative rewards program and including personalization;

FIG. 11 illustrates another example template usable in a simple purchase transaction system;

FIG. 12 illustrates another example non-personalized template usable in an alternative purchase transaction system; and

FIGS. 13A-13H are an entity relation (ER) diagram usable for constructing a commercially suitable database for use implementing an accordance with the principles of the invention.

### DETAILED DESCRIPTION

1. Summary Overview

In summary overview, the invention overcomes the shortcomings existing in the prior art by offering an improved way for merchants to increase access to their goods and/or services in a targeted manner over the internet.

One method employing the principles of the invention features the linking of merchant sites. The method employs the principles by closing an on-line sale to a customer, including receiving payment information from the customer, passing a reason code to a secondary merchant, receiving an indication that the customer has authorized a transfer of the identification and payment information to the secondary merchant, and providing the identification and payment information to the secondary merchant following receipt of the indication.

Preferred embodiments employing the principles may also include one or more of the following: transmitting a token to the secondary merchant; receiving the token and a validator from the secondary merchant; identifying the reason code from among multiple reason codes; awarding points to the customer related to the on-line sale; identifying the reason code from among multiple reason codes based upon at least one purchased product identifier; associating the customer behaviors with multiple reason codes; associating the multiple reason codes with an incentive program; associating the reason code with a customer loyalty program reward parameter; or encoding the reason code and token according to a specified scheme.

An alternative method involves targeting offers based upon purchase transactions between customers and partners. Application of the principles involve receiving a reason code and a customer identifier from a partner indicating that a customer has completed a purchase of an item from the partner within a specified classification; displaying an offer, to the customer graphically on-line, according to data associated with the reason code; while the customer is still connected to the partner; receiving an acceptance of the offer from the customer; establishing a secure communication connection with the partner; sending the customer identifier to the partner; receiving a customer payment information from the partner; and processing the acceptance using the customer payment information.

Additional preferred embodiments employing the principles may include one or more of the following: decoding a data item to obtain the reason code and the customer identifier; receiving SKU information from the partner and assembling the offer based upon the SKU information; or receiving prioritization information from the partner for a compound purchase and assembling offer components according to the prioritization information.

An example system employing the principles is made up of a database containing URLs of merchants, transmittable display templates containing items of a secondary merchant for display to a customer of a primary merchant, and an internet connection, the database correlating reason codes with the URLs and the display templates such that, when a reason code is received from a source and the database is accessed using the reason code as a primary key, the database will identify a display template and a URL to which the display template will be transmitted.

The principles of the invention will be evident from the following discussion of certain representative embodiments and representative applications of those principles with reference to the figures.

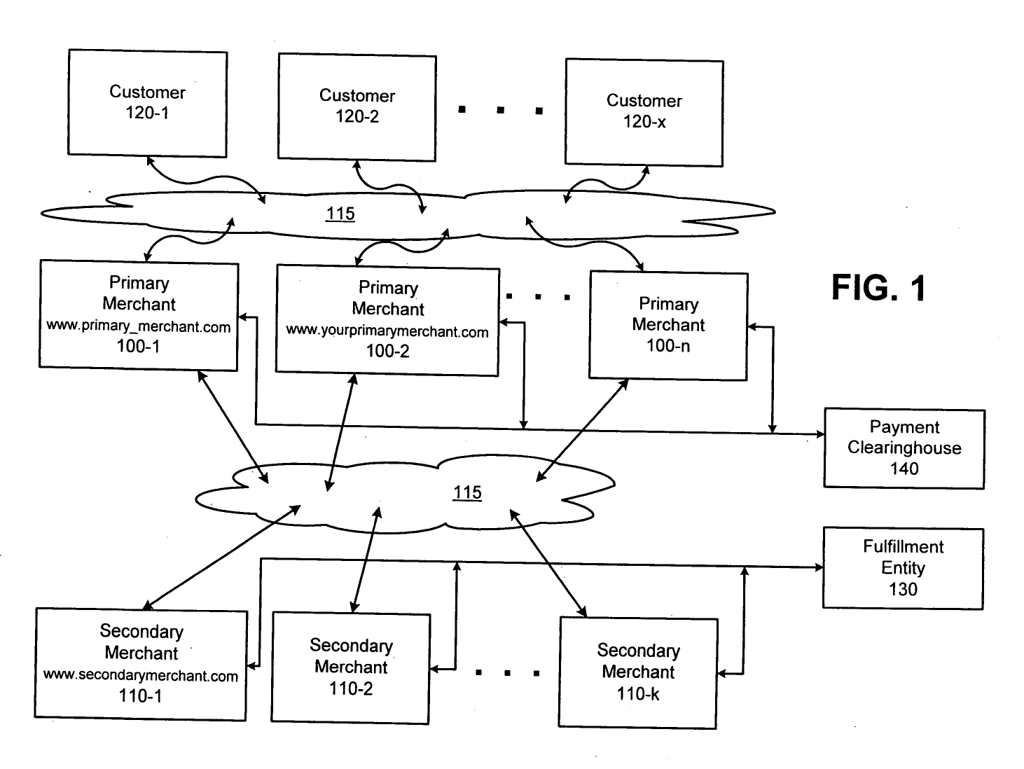

FIG. 1 shows an example system incorporating the invention. Although multiple primary 100 and secondary 110 merchants are shown in FIG. 1, for simplicity, the invention will be described with detailed reference to a single primary merchant 100, a single secondary merchant 110 and a single customer 120. It will be understood from the disclosure that the exact implementation of any specific primary 100 or secondary 110 merchant will depend upon the subject matter of the particular merchant's business which is independent of the invention.

The system includes primary merchants 100 (individually 100-1 through 100-n) and secondary merchants 110 (individually 110-1 through 110-m) each of which is configured to send and receive data over the internet 115 to and from individual customers 120 (individually 120-1 through 120-x), as well as communicate with one or more fulfillment entities 130 (such as magazine publishers, merchandise order fulfillment houses, or service providers), and authenticate customer credit card or other payment data through an appropriate payment clearinghouse 140. The designations “primary” and “secondary” are with reference to a particular customer and transaction, the primary merchant 100 being the merchant with whom the initial transaction takes place and the secondary merchant 110 being the merchant whose offer is related to or based upon the interaction of the customer and primary merchant. Thus, a primary merchant 100 with respect to one transaction may also be a secondary merchant 110 with respect to a another transaction. Moreover, the invention is readily extensible so that a given primary merchant may be involved with several secondary merchants and vice versa.

Customers 120 include parties accessing the website of a primary merchant 100, for example, a primary merchant 100-1 with a website identified as “www.primary_merchant.com” or a primary merchant 100-2 with a website identified as “www.yourprimarymerchant.com”. Customers 120 make “purchases” at the website of a primary merchant 100. In the most common commercial case, the “purchase” involves a fee based purchase of goods or services. The purchase is considered consummated or closed upon provision by the customer 120 of payment information, preferably on-line. As used herein, the term credit card is used to generally and expansively refer to any monetary payment using credit card, debit card, charge card, electronic wallet, stored value card or module, on-line scrip, etc.

Alternatively, the “purchase” can be a specified or predefined behavior of a visitor to the site or compliance with some suitably defined criteria. In this circumstance, the “payment” occurs when the customer completes the desired behavior or satisfies the criteria. For example, a “purchase” may be considered consummated upon one or more of the following: answering a questionnaire, providing an e-mail address, registering a friend, opening an account, visiting one or more links, or accessing some part of the website more than a specified number of times within a prescribed period, etc.

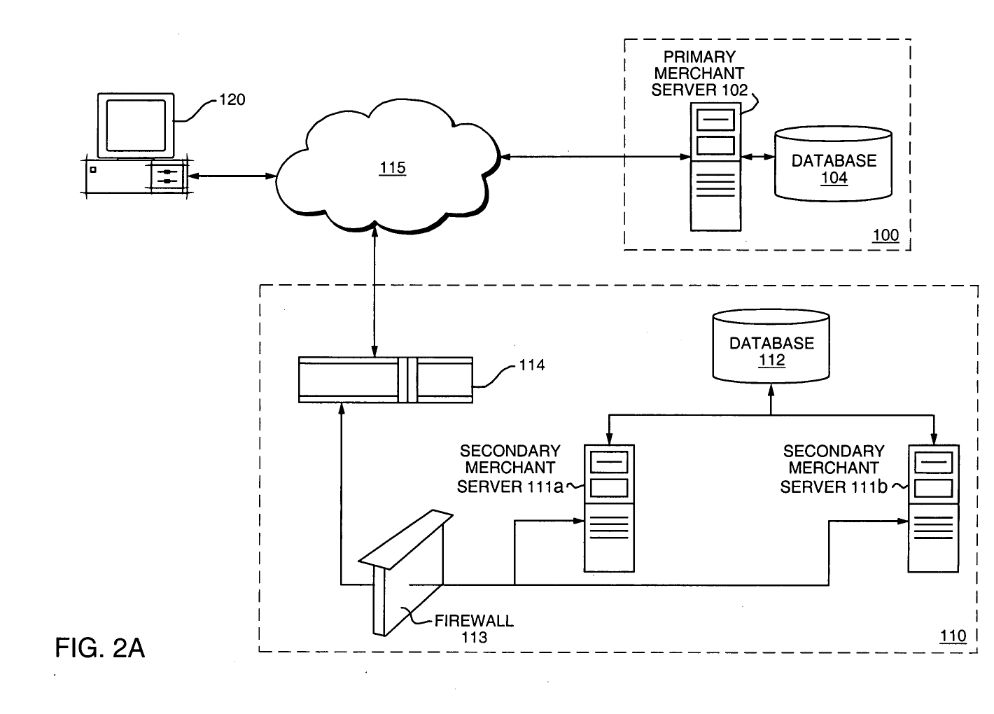

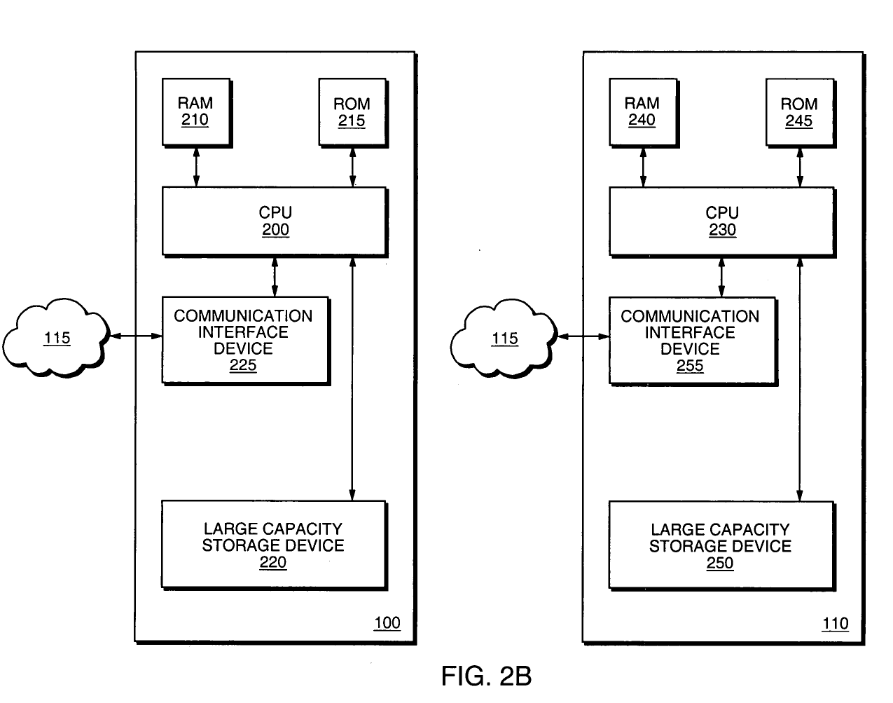

FIG. 2A is a more detailed view of a single customer 120, primary merchant 100 and secondary merchant 110 from FIG. 1.

The primary merchant 100 includes a commercially available server 102 of any type capable of operating in accordance with the dimension herein. The server 102 is used to access a database 104 for storage and retrieval of information contained therein.

The secondary merchant 110 includes a pair of servers 111a, 111b of any commercially available type capable of operating in accordance with the discussion herein. The servers 111a, 111 b both access a database 112 for storage and retrieval of the information contained therein. The servers 111a, 111b and database 112 are preferably located behind a firewall 113 for security purposes. Although only one server 111a is required, the addition of one or more additional servers 111b etc. allows the handling of higher volume of traffic. Where two or more servers 111a, 111b are used, an optional router 114 connected to the internet 115 acts as a load balancer to distribute the load between the servers 111a and 111b by directing traffic to the less busy of the two.

For clarity, the detailed structure of one example primary merchant 100 and secondary merchant 110 is further described below in connection with FIG. 2B.

The primary merchant 100 preferably uses a server 102 or processor-based system that is accessible by customers via the internet and using a web browser such as Internet Explorer 3.0 or Netscape Navigator 3.0. The primary merchant 100 system includes processing power, storage and communications capability and capacity sufficient for viably operating a website while interacting with a secondary merchant 110. The system includes a Central Processing Unit (CPU) 200 which executes program code stored in one or more of Random Access Memory (RAM) 210, Read Only Memory (ROM) 215, and a large capacity secondary storage 220, or disk array, to carry out the functions and acts described in connection with the primary merchant 100. The primary merchant 100 has a presence on the internet in the form of a web site and will allow its customers to purchase items (for example, goods, information or services) offered by a secondary merchant 110.

Operationally, the primary merchant 100 executes software with the CPU 200 to obtain a secondary merchant 110 identifier, such as a Universal Resource Locator (URL), which facilitates establishing a communication connection between the customer's browser and the secondary merchant 110. This connection allows the customer 120 to view an offering made by the secondary merchant 110. As described in greater detail below, the primary merchant 100 system also provides a reason code and a token to the secondary merchant 110.

The primary merchant 100 system also includes a conventional communication interface device 225 for communicating with others via the internet, using known techniques. The interface device 225 is used to set up a communication link between the primary merchant 100 and the secondary merchant 110, through which customer information is passed by the primary merchant 100 to the secondary merchant 110, to aid the secondary merchant 110 in processing of a customer 120 order, with a minimum input on the part of the customer.

A secondary merchant 110 preferably also comprises a server 112 or a processor-based system. As shown, the secondary merchant 110 system includes processing power in the form of at least one Central Processing Unit (CPU) 230, Random Access Memory (RAM) 240, Read-Only Memory (ROM) 245, large capacity secondary storage 250, such as a disk array, and a communication interface device 255 for communicating via the internet according to known techniques. The secondary merchant CPU 230 interacts with RAM 240, ROM 245, and large capacity secondary storage 250, to execute stored program code according to conventional data processing techniques to carry out the functions and acts described in connection with the secondary merchant 110.

Depending upon the circumstances, the secondary merchant 110 may, or may not, have a presence on the internet in the form of a generally accessible web site. For example, as shown in FIG. 1, one secondary merchant 110-1 has a generally accessible website “www.secondary_merchant.com” whereas another of the secondary merchants 110-2 does not.

Depending upon the particular application and information to be passed, the communication among the primary merchant 100, secondary merchant 110 and customer 120 may also involve one or more levels of security, such as password protection and/or encryption according to conventional data processing and secure communication techniques.

As will be described in more detail below, upon receipt of a reason code from the primary merchant 100, the secondary merchant 110 provides an offer to the customer in a specified style indicative of the primary merchant 100. In this manner, visual continuity or the “look-and-feel” of the primary merchant's interface can be maintained for the customer. This is particularly useful to maintain the customer's level of confidence and trust, where the customer knows the primary merchant but not the secondary merchant or where neither the primary merchant 100 nor the secondary merchant 110 want the customer 120 to know of the secondary merchant 110 existence or identity.

Following display of the secondary merchant 110 offer, if the customer accepts offer, communication occurs between the primary merchant 100 and the secondary merchant 110 during which time customer information is passed by the primary merchant 100 to the secondary merchant 110 to aid in order processing with, as noted above, a minimum of additional customer 120 action, if any.

Payment clearinghouse 140 receives and validates customer payment when sent by a merchant. Clearinghouse 140 preferably comprises a credit card clearinghouse capable of verifying credit card status, and appropriately charging and refunding amounts to credit cards. Clearinghouse 140 receives the credit card information from secondary merchant 110 following a transaction or as part of a batch submission and transmits its response through secure transmission lines. In alternative configurations, clearinghouse 140 could authenticate charges and refunds for bank accounts, stored value cards or modules, or on-line wallet. Data communicated between agent 110 and clearinghouse 140 is preferably encrypted using conventional encryption techniques to ensure that third parties cannot misappropriate transmitted information.

2. Tokens and Reason Codes

The system uses staged information transfer using a token and a reason code to accomplish the information transfer between a primary merchant's server and secondary merchant's server with data security.

The token is a unique incrementing number maintained by the primary merchant 100 site. Token generation on the primary merchant 100 site starts with an arbitrary “seed” number and then increments it ad infinitum via a preferably random, small increment, for example, an increment less than 10. More sophisticated tokens using alpha characters or images, for example, may also be used. However, token generation and verification becomes more complex. This token is stored by the primary merchant 100 when a customer makes a purchase along with the associated customer's information and the current date/time. Depending upon the implementation employed by the primary merchant 100, the token may be stored in a field of a customer database, or a separate database.

The reason code is both a value and an “identity” field within a database maintained by, or for, the secondary merchant. It may be a number, an alpha-numeric string or some other indicator usable to uniquely and discretely identify stored information. Each reason code correlates to information made up of a number of specified parameters which are each predefined, for example, by agreement between the primary 100 and secondary 110 merchants or by default to some value. Depending upon the particular implementation a particular reason code may uniquely identify all specified parameters, share parameters, or be made up of separate discrete sub-codes with each identifying one or more parameter(s). In other arrangements, the reason code may include one or more dynamically specifiable parameters or data values for customization purposes. Although no specific form or format is required for any given reason code, using a complex reason code may adversely affect performance in some applications. Thus, in its most straightforward implementation, a reason code is an integer of a specified number of digits.

In one embodiment, the secondary merchant 110 assigns new reason codes, creates and populates table entries for each, and the reason code is set as the primary key for a record in the database. In other embodiments, the primary merchant 100 will specify the reason codes, for example, in the case where two or more secondary merchants can be the source of offers presented at a primary merchant site. The numeric, alphabetic or alpha-numenric characters used for any given reason code is arbitrary. Also reason codes may persist indefinitely or for a limited or predetermined time period.

Since a token uniquely identifies customer visit, sent by the primary merchant 100 to the secondary merchant 110 site, the combination of the token and reason code uniquely identify a customer from a particular primary merchant 100 site at a particular point in time.

When a primary merchant 100 site passes a customer to the secondary merchant 110 following a transaction, the secondary merchant system accepts the reason code from the primary merchant 100 site. The reason code is associated with certain basic information and greatly minimizes the amount of information a primary merchant 100 needs to provide to the secondary merchant 110 for a customer transaction. An exemplary illustration of the kind of information that could be part of a database record associated with each reason code is shown in Table 1.

primary merchant 100 id (affiliate ID and store number).
reason for the referral (e.g. reward for purchase or behavior)
limitation on items to display in offer
maximum that can be redeemed
maximum item units allowed
graphic layout use information (logo to use, color scheme, etc.)
preferred or priority for items to display
source code for offers to be displayed
value awarded for redemption.
e-mail text templates to use (for both “order received” and “order
fulfilled” confirmation emails)
customer service phone number to use
primary merchant 100 home URL
primary merchant 100 specific return email address
processing fee to charge (if any)

The “primary merchant 100 id” identifies an affiliate merchant and, where appropriate, a store number.

The “reason for the referral” identifies the type of reward (e.g. reward for purchase or for specified behavior)

The “limitation on items to display in offer” specifies any limitation placed by the primary merchant 100 upon the items the secondary merchant 110 can offer.

The “maximum that can be redeemed” specifies a limitation on how many “points” or how much value that can be redeemed within a specified number of visits or time period.

The “maximum item units allowed” specifies a limitation on how many offered units can be purchased or obtained by redemption.

The “graphic layout use information” identifies the primary merchant 100 logo to use, any specified color scheme, a particular template or frame, as well as any other visual related information used to maintain a consistent “look and feel” between the primary merchant 100 site and the offering displayed by the secondary merchant 110 in a new window or frame, etc.

The “preferred or priority for items to display” identifies an ordering or grouping for the items to be displayed, for example, if the secondary merchant is a redemption site offering magazine subscriptions for reward points and the SKUs for the purchases identify baby items, housewares and toys, then parenting-type magazines and beauty magazines are to be displayed before consumer goods rating magazines.

The “source code for offers to be displayed” is a field which identifies the source (i.e, the primary merchant), the time period for the corresponding offer and possibly other details regarding the offer.

The “value awarded for redemption” identifies the amount of value awarded for the instant transaction.

The system may be constructed to send e-mails in addition to providing on-screen notification. As a result, the “e-mail text templates to use” specifies the particular form text to be incorporated into an “order received” or “order fulfilled” confirmation e-mail.

The “customer service phone number to use” identifies customer service contact information, for example, to handle questions regarding points, cancel subscriptions, return merchandise, etc.

The “primary merchant 100 home URL” is used to initiate a secure connection between the primary 100 and secondary 110 merchants.

The “primary merchant 100 specific return email address” is used for e-mail communications from the secondary merchant 110 to the customer 120 using the “look-and-feel” of the primary merchant 100.

The “processing fee to charge” identifies a particular processing and handling fee to be charged to the customer, if any.

3. Information Transfer

When the customer completes shopping on the primary merchant 100 site, the following interactions occur at and between the primary merchant 100 and secondary merchant 110 to allow the secondary merchant 110 to make its offer to the customer.

The primary merchant 100 generates or assigns a token to the customer 120 and identifies the applicable reason code to be used for this customer transaction. The token and reason code are then suitably encoded together for secure transmission. For example, both the token and the reason code are used to generate error detection information, such as a check sum, or error detection and correction information. The resultant token, reason code and error detection (and correction) information is then encoded into a transmittable unique identifier by “scrambling” them together in a precisely defined way so that the secondary merchant 110 receiving the unique identifier can perform the unscrambling. This encoded information is then transmitted to the secondary merchant 110. Optionally, the customer's first name may also be sent, so that it can be incorporated into the initial customer display. A flag indicating whether the primary merchant 100 site has all the additional customer information which would be needed by the secondary merchant to consummate a transaction, for example, a credit card number and address for billing and shipping may optionally be sent too. If such a flag is used, the secondary merchant 110 will know that all necessary information will be available from the primary merchant 100. In other embodiments, the flag may indicate to the secondary merchant 110 that particular information the secondary merchant 110 may need, the primary merchant 100 does not have. Thus, the secondary merchant can know what, if any, information it needs to obtain from the customer 120 as opposed to the primary merchant 100.

The secondary merchant 110 receives these transmitted parameters and decodes the information to obtain the underlying token and reason code. The error detection information is used for validation of the transmission and the reason code is extracted and looked up in a database of reason codes. If both pass these tests, then the token and reason code will each be stored in another table along with the date/time for later use. Since a token is unique for a particular customer 120 of primary merchant 100 and the token is unique to a customer across all primary merchants, if the token is found to already exist in the table or the reason code does not exist in the database this indicates a problem, and the customer is denied access.

The secondary merchant 110 site uses the reason code received to look up the correct primary merchant 100 site URL in its database. A secure socket layer (SSL) connection is then established between secondary merchant 110 and the site identified by the URL.

The offer is then displayed for the customer 120 in the conventional manner, according to the parameters specified by the reason code. If the customer 120 rejects the offer, the secondary merchant 110 disconnects. If the customer 120 accepts the offer, the operation proceeds as follows.

A method is then sent to the identified URL with two pieces of information, the received token and a validator. The token is provided in order to allow the primary merchant 100 site to identify the correct customer. The validator is an arbitrarily agreed upon string and/or value that is used as a password to insure that only the secondary merchant 110 will be able to gain access to the customer supplied information held by the primary merchant 100, such as credit card information and/or billing address. A post to the primary merchant 100 URL is made with the validator and token attached and looks, for example, as follows:

http://primary_merchant.com/GetCCInformation.asp?token=1234&validator=password18

where “GetCCInformation.asp” is an Active Server Pages method constructed to obtain the appropriate information from the primary merchant 100.

Upon receiving the request for information, the primary merchant 100 site looks at the two pieces of information it has received (validator and token) and checks both. The validator is checked to ensure that the password transmitted is the same as the one mutually agreed upon by primary merchant 100 and the secondary merchant 110. If the validator is not correct, an XML token attribute field in an XML schema is modified to indicate an invalid validator. Next, the primary merchant 100 site looks up the customer information based on the token received from the secondary merchant 110. If the token cannot be found, the XML token attribute field is modified to indicate that the token was not found. The secondary merchant 110 can then be informed, and react, according to the XML token attribute field, for example, by informing the customer of a problem and suggesting they call the primary merchant 100 to resolve it.

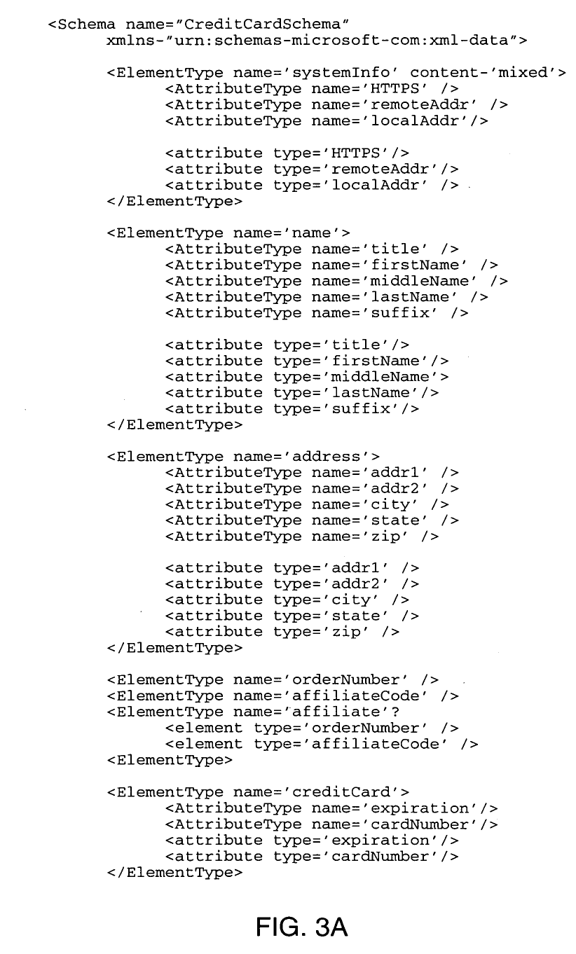

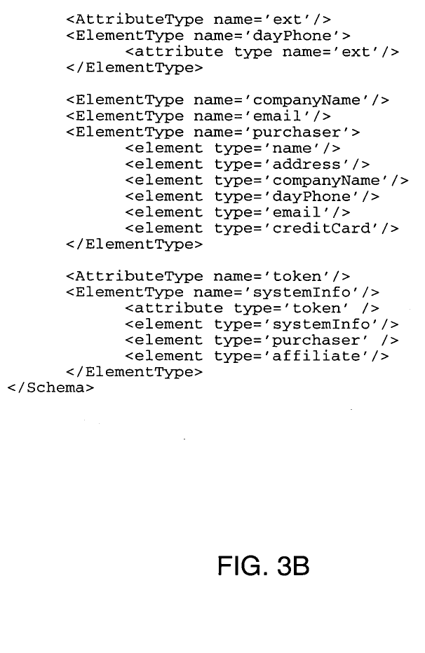

If both the validator and token verify, the available user information is retrieved by the secondary merchant 110, from the primary merchant 100 who has collected the information as part of the original purchase. This retrieval by the secondary merchant 110 is accomplished using an XML document created from the schema which is populated with all fields available from the primary merchant 100 and then returned to the primary merchant 100 site. FIGS. 3A and 3B together are an example schema which act as a template defining the particular information to be passed from the primary merchant 100 to the secondary merchant 110.

In the example schema, the token attribute described above corresponds to the CreditCardInfo element of the schema and is set as follows:

If the validator is missing from the URL, set the token to ERR-NOVALIDATOR.

If the token is missing from the URL, set the token to ERR-NOTOKEN.

If the token or validator is present but invalid, set the token to ERR-BADTOKEN.

Otherwise, the token is set to the value that was originally passed from the primary merchant 100.

If any information needed for a field is not available from the primary merchant 100, the secondary merchant 110 will prompt for the missing information, or some minimum subset of the total information containing the needed information. For example, if the Zip Code is not available, the secondary may prompt for only the Zip Code or for the city, state and Zip Code. If the primary merchant collected no information, the secondary merchant 110 will then collect all the information it needs.

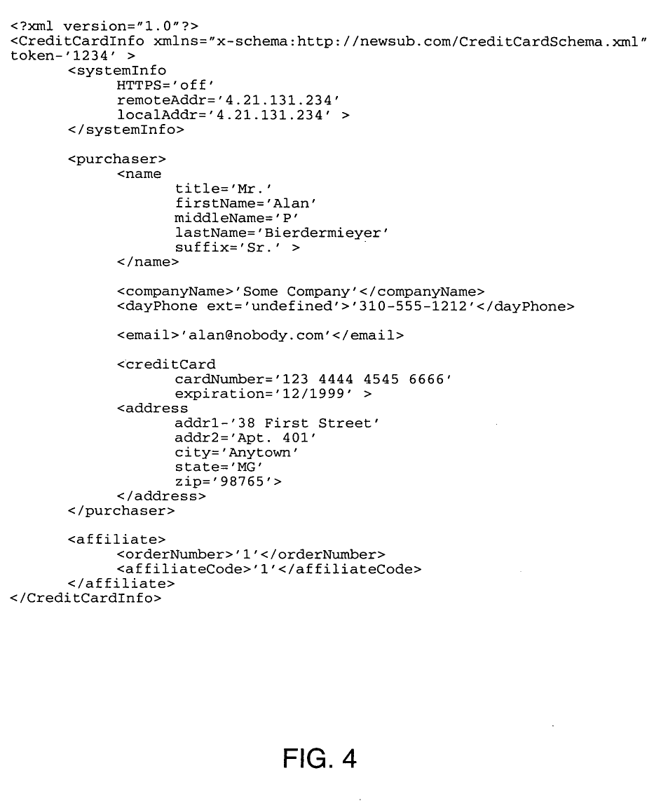

FIG. 4 is the example schema of FIGS. 3A and 3B as it would be returned to the secondary merchant 110 populated with the desired information.

Advantageously, the system outlined above ensures a high degree of security without unduly burdening the secondary merchant 110 site. As a result, the system and its operation is also aptly suited for use as part of an incentive or rewards program, where the predominant part of the rewards program may be administered by the secondary merchant 110.

4. Data Flow

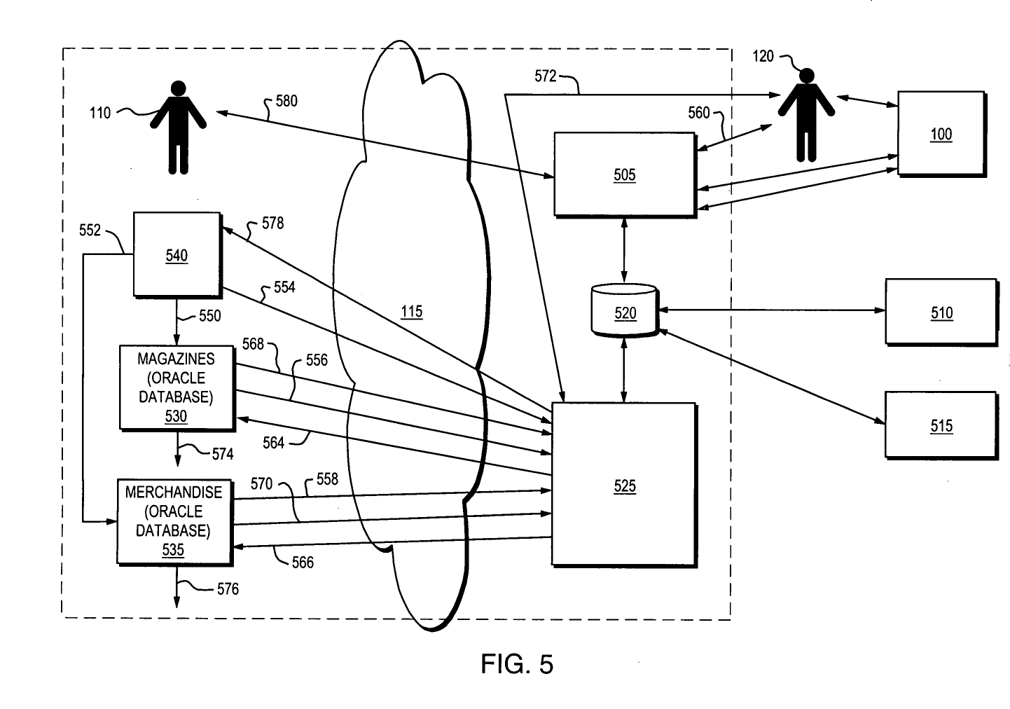

FIG. 5 illustrates the data flow for a commercially suitable rewards system implementing the invention and offering both merchandise and magazine as incentive rewards. In FIG. 5, the cloud represents the internet 115, with lines crossing the dashed line representing a flow via an internet connection. All other connections are represented as network connections, for examples over a WAN or intranet. Unless otherwise noted, the data flows occur periodically, but are independent of each other with respect to time.

As shown in FIG. 5, a primary merchant 100 interacts with a customer 120. The customer places an order which triggers an award of a specified number of points and the packaging and transfer of a reason code and token from the primary merchant 100 to the points layer logic 505 of the secondary merchant 110.

As shown, the secondary merchant 110 also operates additional businesses 510, 515 selling merchandise and magazines on-line 510 and an additional rewards program-type business 515. Although the other business 510, 515 do not link to other merchants, since much of the information pertaining to transactions in each can be similarly formatted, a common database 520 and logic 525 is used for all three businesses. To facilitate this arrangement, separate magazine order management systems and merchandise order management systems 530, 535 are respectively maintained for magazine related information and merchandise related information. A common management system 540 coordinates and manages the distributed operation. The various systems 530, 535, 540 may themselves be implemented by one or more servers and employ other databases and logic which contribute to the end result but are not pertinent to understanding the invention described herein. Additionally, the various components of the systems and logic 505, 520, 525, 530, 535, 540, can be hosted at one or more locations remote from the main secondary merchant 110 site or on-site. The magazine order management system and/or merchandise order management system can be optionally be configured to convert an order or reward to a continuous or open-ended subscription at the end of the term ordered or reward term, for example, as set forth in U.S. patent application Ser. No. 08/762,007 filed Dec. 11, 1996, incorporated in its entirety herein by reference.

To effectuate the operation of the secondary merchant 110 system as a whole when made up of discrete systems, data flows among and between the various components. By way of example, a magProdInfo file is sent (550) from secondary merchant 110 to the magazine order management part of 530 system. This file contains information such as SKU, magazine title, UPC, and/or ISSN, along with a magOfferInfo file which contains offer specific data such as price and number of issues and includes a PriceInBonusPoints field which contains the price of the offered items converted to points. A merchProdInfo file is sent from secondary merchant 110 to the merchandise order management part 535 of the system (552). This file is similar to the magProdInfo file, but applies to merchandise instead of magazines. A merchOfferInfo file is also sent from secondary merchant 110 to the merchandise order management part of the system. This file is similar to the magOfferInfo file, but applies to merchandise instead of magazines. The magMarketingInfo is a flow sent (554) from secondary merchant 110 directly to the common database logic 525. This flow includes a magazine Product Marketing Information file (title, category, keywords, descriptions, affinities) and magazine Cover Graphics Files. A merchMarketingInfo is also sent and is a flow that is similar to magMarketingInfo, but for merchandise. The scrubbedMagProdInfo file is sent (556) from the magazine order management part of the system to the common database logic 525. This file is similar to the magProdInfo file—but the data is “scrubbed” meaning it has been subsequently reduced in volume by the magazine order management part of the system which rejects invalid records. A scrubbedMagOfferInfo file is also sent from the magazine order management part of the system to the common database logic 525. This file is similar to the magOfferInfo file with the data scrubbed by the magazine order management part of the system. A scrubbedMerchProdInfo file (558) is sent from the magazine order management part of the system to the common database. This file is similar to the merchProdInfo file with the data scrubbed by the magazine order management part of the system. A the scrubbedMerchOfferInfo file is also sent from the magazine order management part of the system to the common database. This file is similar to the merchOfferInfo file with the data scrubbed by the magazine order management part of the system. A data flow (560) is caused by the customer link into the points site 505 interface along with the transfers of points earned, token and reason code. A flow (562) results from customer link back to the primary merchant site 100 after rejecting the offer or redeeming the points earned. When the customer redeems points for magazines or merchandise, the system notifies the customer that the order is being processed via an html dialog, which may be augmented or replaced by an e-mail message. A magKeyEntryInfo file is sent (564) from the common database logic to the magazine order management part of the system. This file contains orders that have been received on the web in a format suitable for the fulfillment system. A merchKeyEntryInfo file is sent (566) from the common database to the merchandise order management part of the system. This file is similar to the merchKeyEntryInfo file. A magOrderAck file is sent (568) from the magazine order management part of the system to the common database. This file contains acknowledgement records of the orders sent to the fulfillment system to ensure orders are not inadvertently dropped during processing. A merchOrderAck file is sent (570) from the merchandise order management part of the system to the common database. This file is similar to the magOrderAck file but is modified for merchandise instead of magazines. A flow (572) is shown representing the points system sending the customer an e-mail confirming the redemption of points for a magazine or merchandise order. A magKeyEntryRejectReport is a report generated (574) by the magazine order management part of the system. These reports contain such metrics as points distributed, points redeemed, units redeemed by SKU, title, publisher, and/or UPC code, units shipped to address, credit card related information. A merchKeyEntryRejectReport is a counterpart report generated (576) by the merchandise order management part of the system. The merchKeyEntryRejectReport is similar to the magKeyEntryRejectReport but applies to merchandise. A flow (578) represents the reports, points, and/or invoicing information flowing back to the secondary merchant 110 system. This information includes such information as points distribution, points redeemed, reason codes, SKUs. A flow (580) represents information exchanged with Customer Service Reps. who are accessible to correct problems, such as adjusting point totals, if they occur.

5. Example Operation

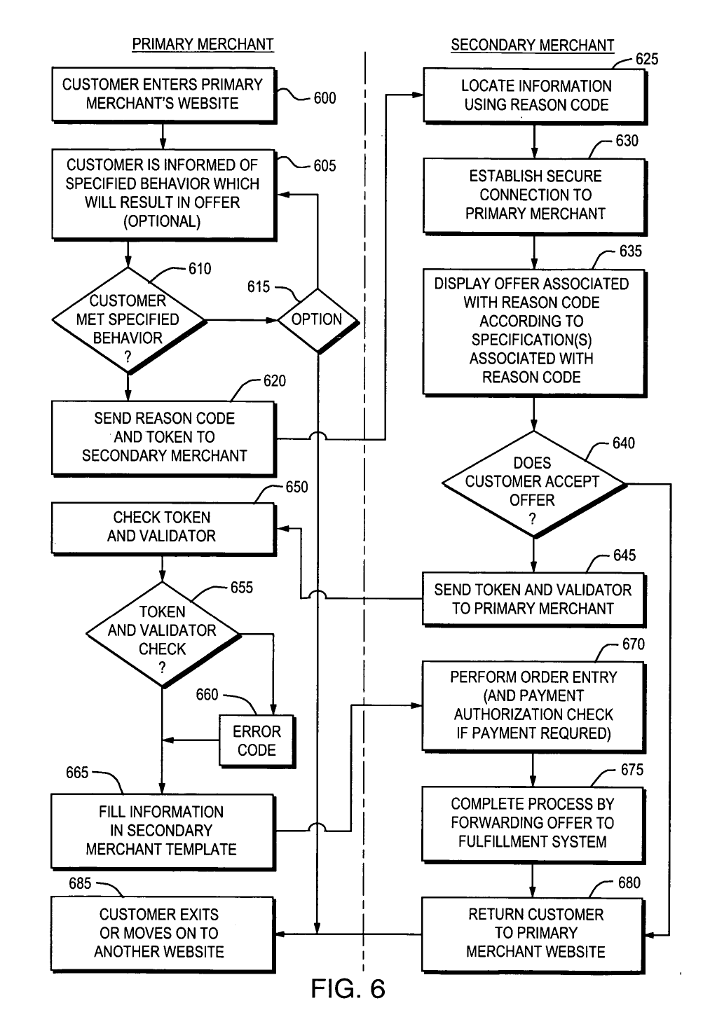

Having described the various elements and their relationships as a general matter, an example embodiment follows with continuing reference to the flowchart of FIG. 6. In this embodiment, the secondary merchant is never identified to the customer. All links and contact information convey the primary merchant's identity only.

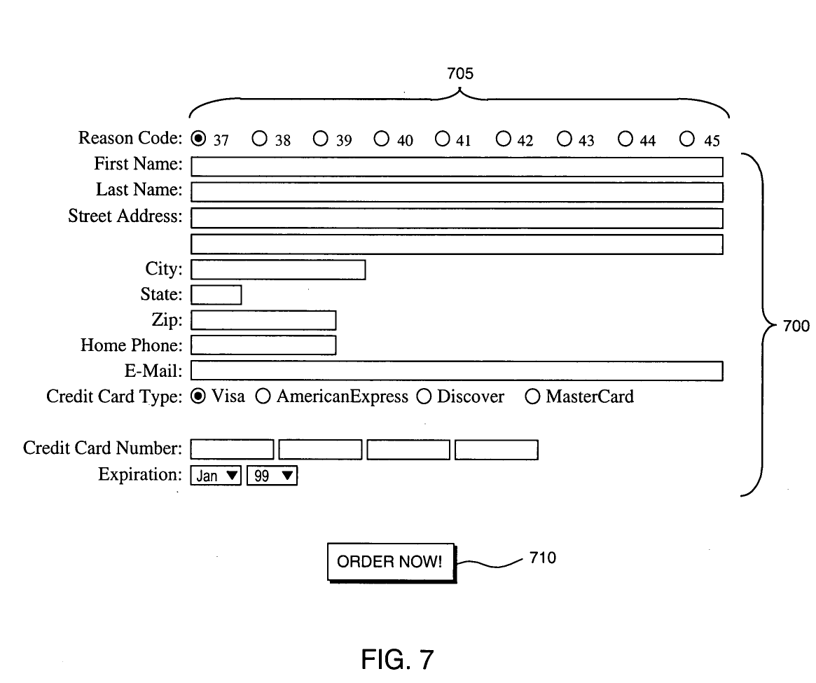

A customer enters a particular primary merchant website (step 600). Although optional, this primary merchant informs the customer that they will earn up to 3,000 points for some specified behavior (step 605), for example, purchasing more than $50 worth of goods and signing up for a free e-mail notification service. The customer adds items to the primary merchant shopping cart and signs up for the service. The customer goes to the order page and is presented with a purchase form such as shown in FIG. 7, which triggers a comparison of the customer's actions against the reward criteria (step 610). The system also implements an option (step 615) whereby, if the customer has not met the specified criteria (step 610), but is close, or is close to a new threshold, the system will re-prompt the customer about the rewards program levels (step 605) or allows the customer to exit which cancels any selected items from the custorher's shopping cart.

The customer completes the order form 700 by entering the specified information required by the primary merchant (name, address, credit card, etc) on this page (FIG. 7).

For purposes of explanation, a set of radio buttons 705 is shown on the order page, each representing a discrete reason code in the system. In actuality, no reason code information would be visible or accessible to the customer. As shown, this primary merchant uses a reward system with 9 possible reward levels, indicated as reason codes “37” through “45”.

In this example, the customer has qualified for a reason code reward level of “37”. The customer clicks on the “ORDER NOW!” button 710 to submit their order. This information goes to the primary merchant's site. The customer's name is extracted from the input information and a token is generated. The token and reason code are combined and transferred to the secondary merchant site, via a flow from the primary merchant's server back through the customer's browser to the secondary merchant site (step 620). As noted above, the token is a counter that is incremented every time it is used and in this embodiment serves two purposes—(a) to validate the transaction (for example, so that points can't be redeemed points more than once), and (b) to uniquely identify the customer so that, when the secondary merchant connects to the primary merchant, the correct credit card information is returned.

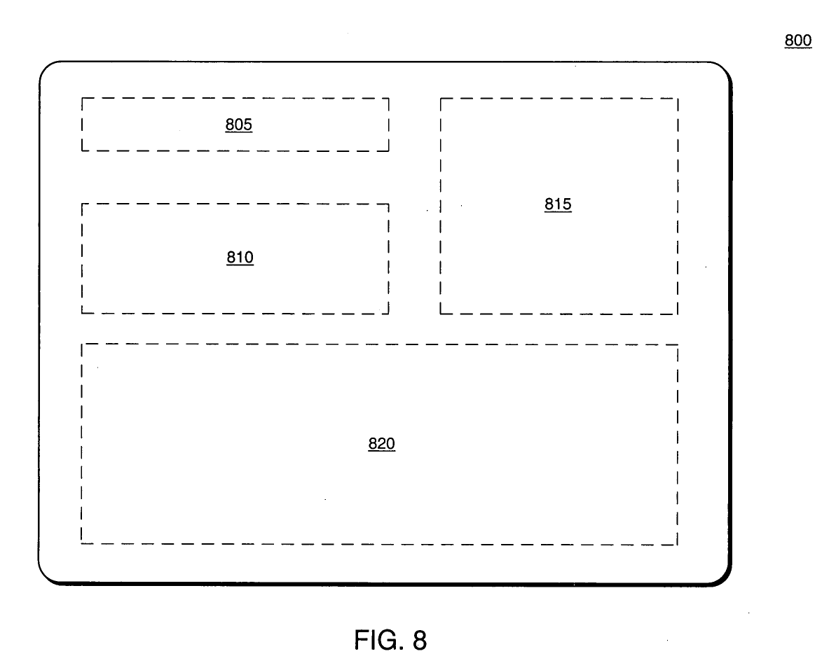

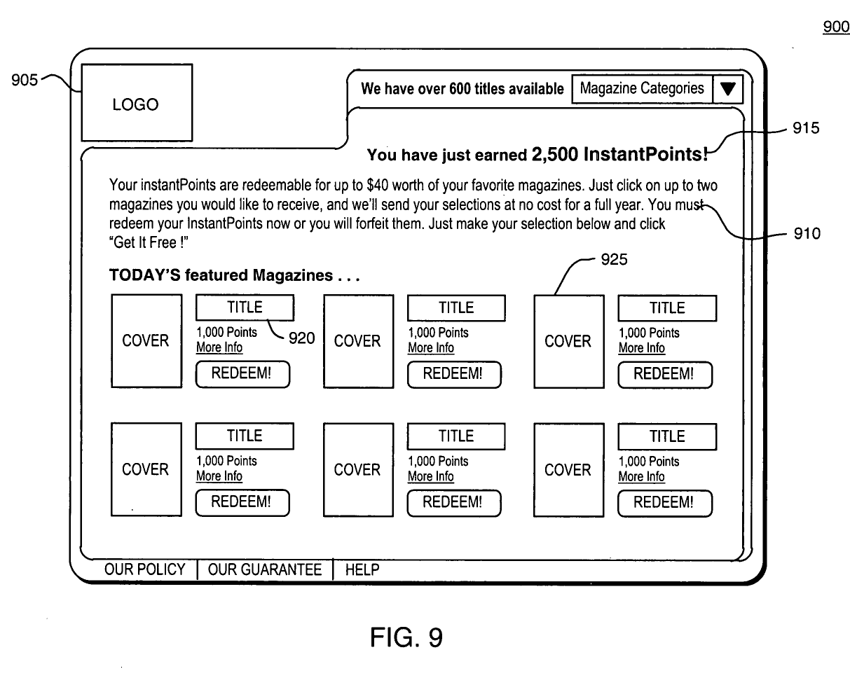

Moving over to the secondary merchant actions, the secondary merchant locates the correlated information using the reason code (step 625) and uses the correlated URL to establish a secure connection to the primary merchant (step 630). Graphical information identified via the reason code specifies a template for the offer. If the primary merchant has not specified a particular template, color scheme, typeface, etc., a generic template (FIG. 8) can be used along with default values. In the template 800 of FIG. 8, areas 805, 810, 815 are available as desired, for one or more of the following: for a logo of the primary merchant, a message regarding the offer, conditions, or offered items/services, and, where applicable, points information. Another area 820 may be used for display of the offered items, or in the case of printed items like magazines, a cover image. Referring back to FIG. 6, the offer template is populated according to the reason code identified specifications and is displayed for the customer in a separate window or frame (step 635). FIG. 9 shows an example display resulting from this template. The display 900 contains the primary merchant logo 905, a message regarding the offer 910 indicating the reward of 2,500 InstantPoints 915 and the dollar equivalent of $40.00. Only six magazines are available to be selected based upon the reason code (and possibly other information regarding the categories related to the purchase) so, although other magazines may be generally available from the secondary merchant, no other magazines or merchandise is displayed. The title 920 and an image of a cover 925 is displayed for each of the six.

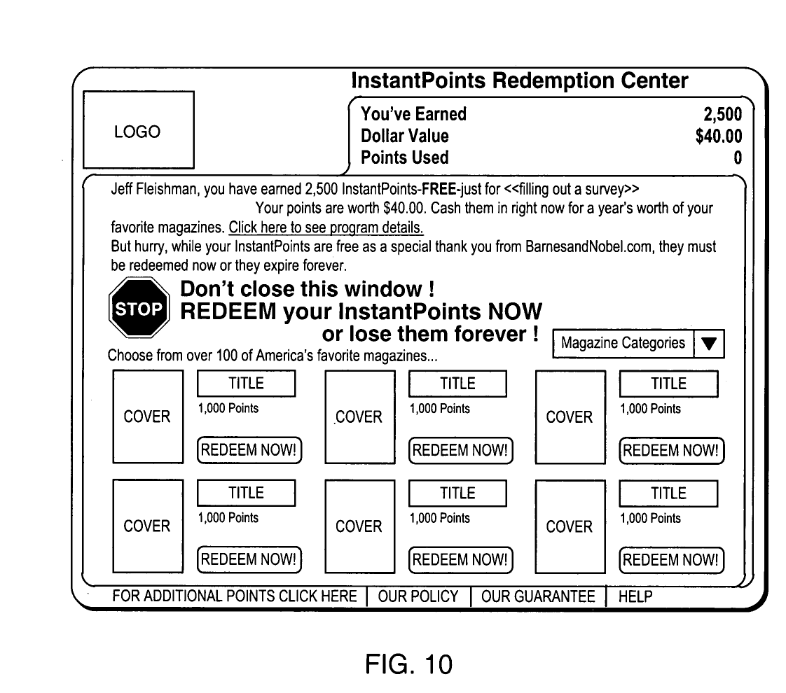

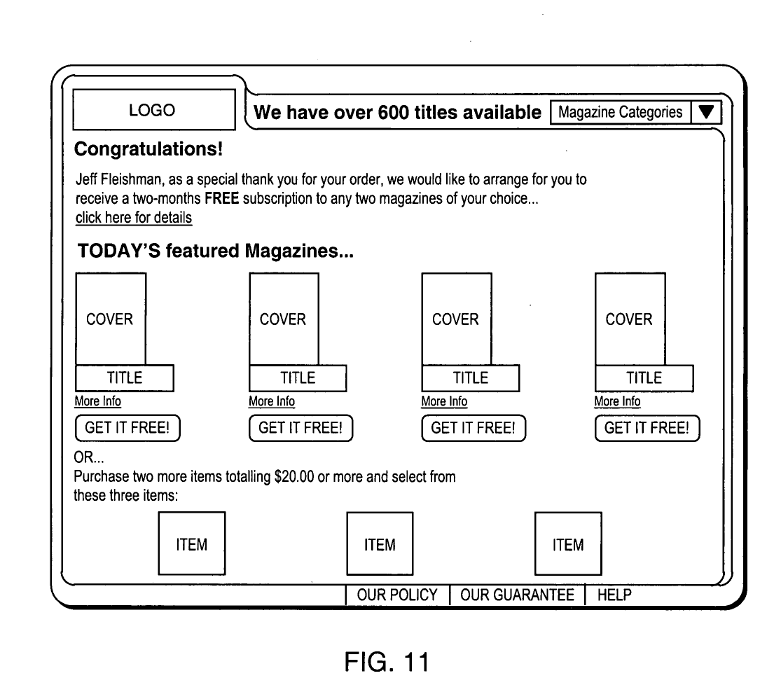

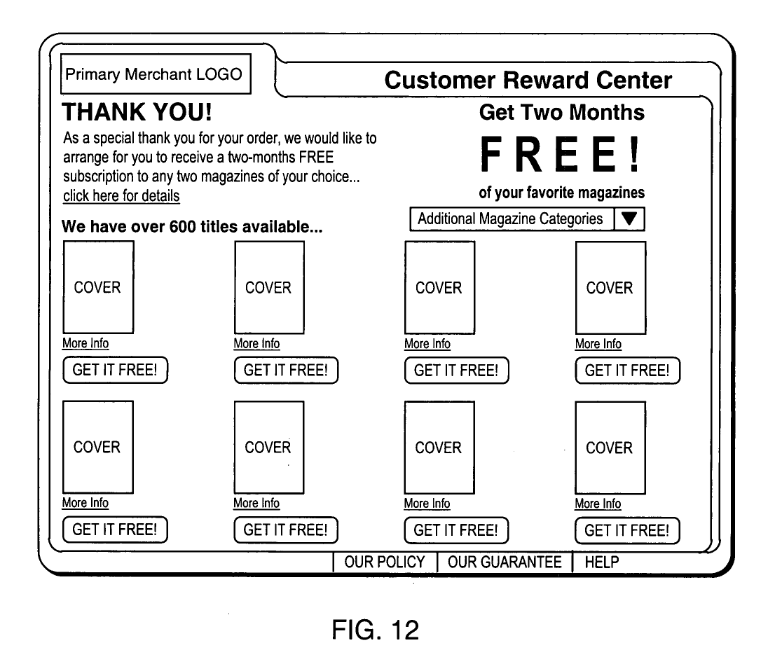

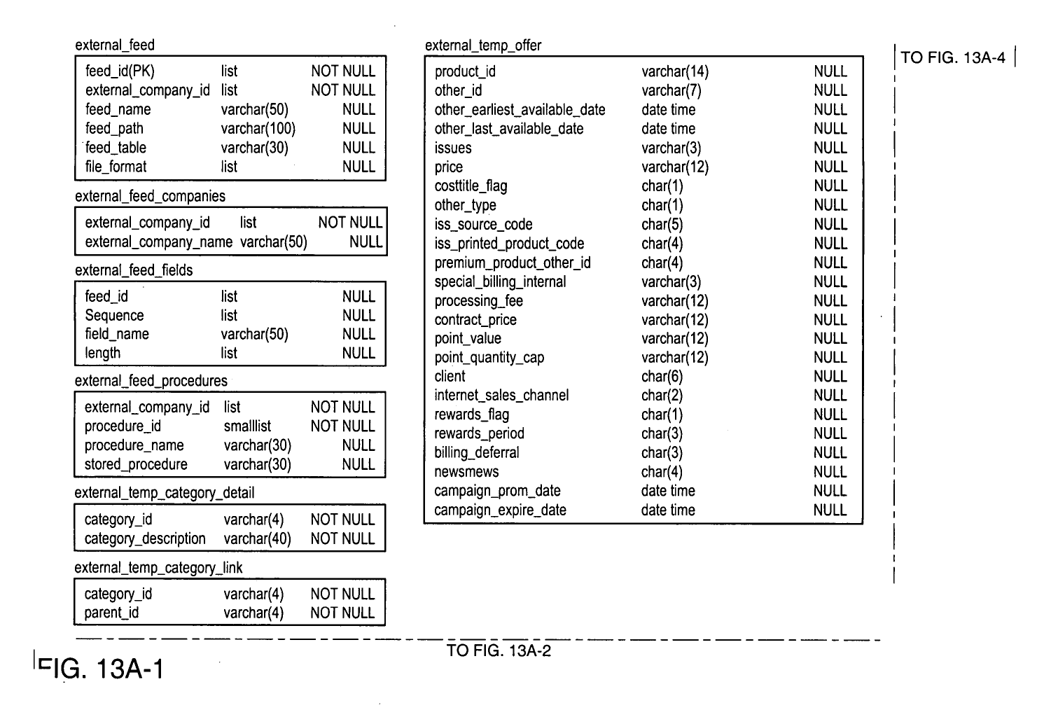

FIGS. 10 through 12 are further example display variants which might be used for magazine offers or, with straightforward modification, for offers of other forms of merchandise or services.

If the customer does not accept the offer (step 640), closing the window returns the customer to the primary merchant website (step 680). If the customer selects at least one of the offered items, in this case magazines, the secondary merchant sends the token and a validator to the primary merchant (step 645). The customer is not prompted for any shipping information because the address and credit card details will be recovered from the primary merchant's server by the secondary merchant's server via a direct server-to-server interaction using a token and an XML document schema.

The primary merchant checks the token and validator for validity (step 650). If one or both is invalid (step 655), an error indicator is placed in the schema to be sent to the secondary merchant (step 660). If both are valid, the schema is filled in as necessary and sent to the secondary merchant (step 665). The secondary merchant performs the order entry operations necessary to initiate a subscription for the customer (step 670).

If, however, the customer had been offered merchandise and, for example, a shipping fee was required, the fee would be charged to the credit card identified in the XML document. Depending upon the amount at issue, credit card authorization could be done at the time of the transaction or could be deferred and batch processed with other small amount charges at the end of a specified period, for example, at the end of each day. If the offer was not part of a rewards system or allowed for the purchase of additional points to augment the current point total, charges would be processed in the same basic manner.

At the appropriate time, the order is forwarded to the appropriate subscription fulfillment system (or in the case of merchandise, an order fulfillment system) (step 675). Once the order entry (step 675) is completed, the customer is returned to the primary merchant website (step 680). The customer may then exit or move on (step 685).

Depending upon the specific implementation, a customer service link may optionally be provided in the form of an e-mail “mailto:”, a telephone number and/or a mailing address. Customer service representatives can selectively have access to the customer's e-mail address, name, billing address, shipping address, credit card number, primary merchant identity, order and reward dates, reward account, order information and confirmation information. Additionally, it may be desirable to selectively allow the customer representatives to access the reason codes and their meanings, the correlation between points, money and/or behaviors.

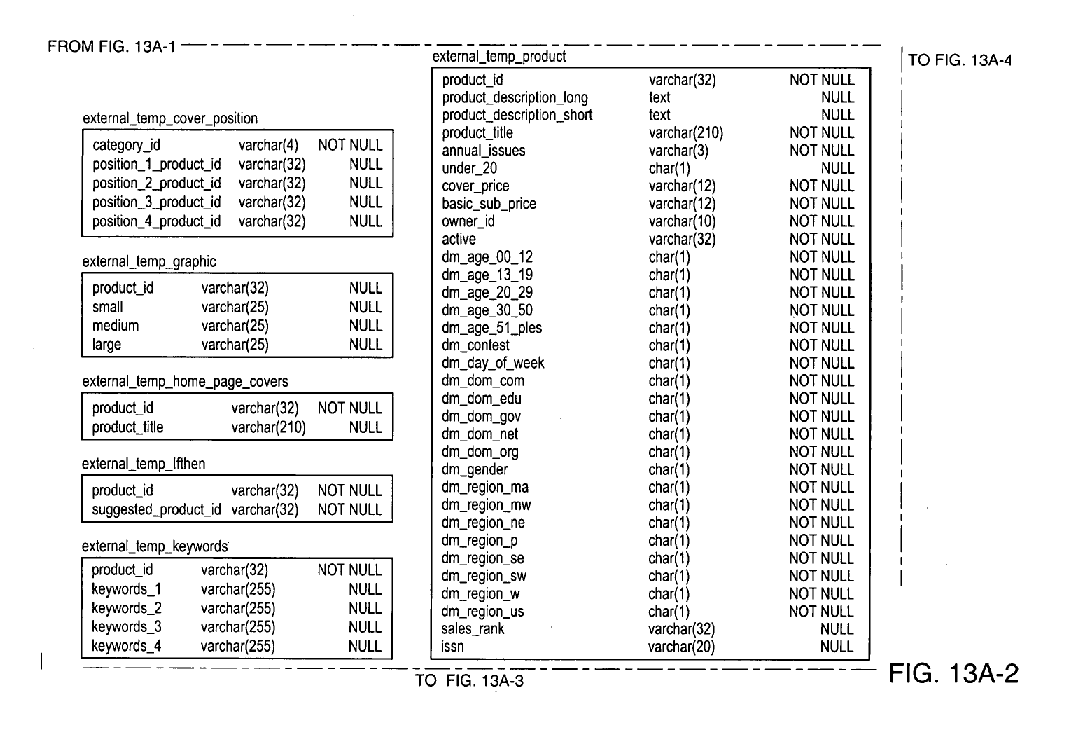

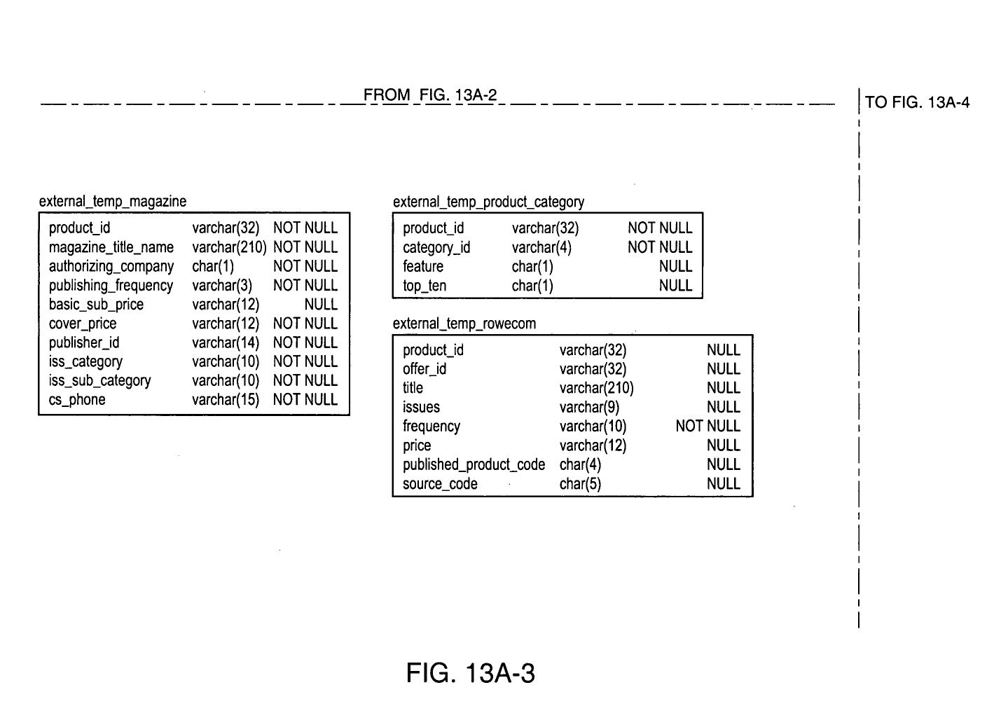

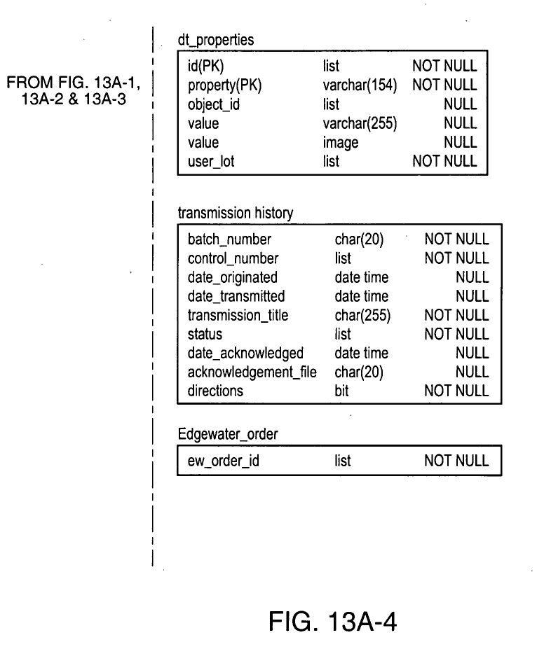

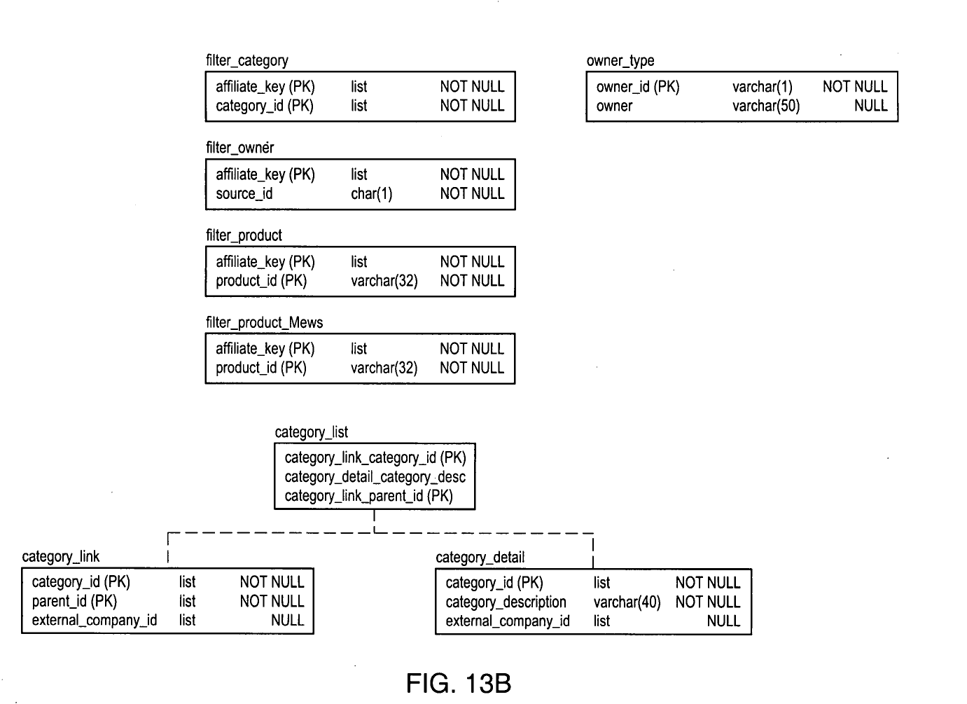

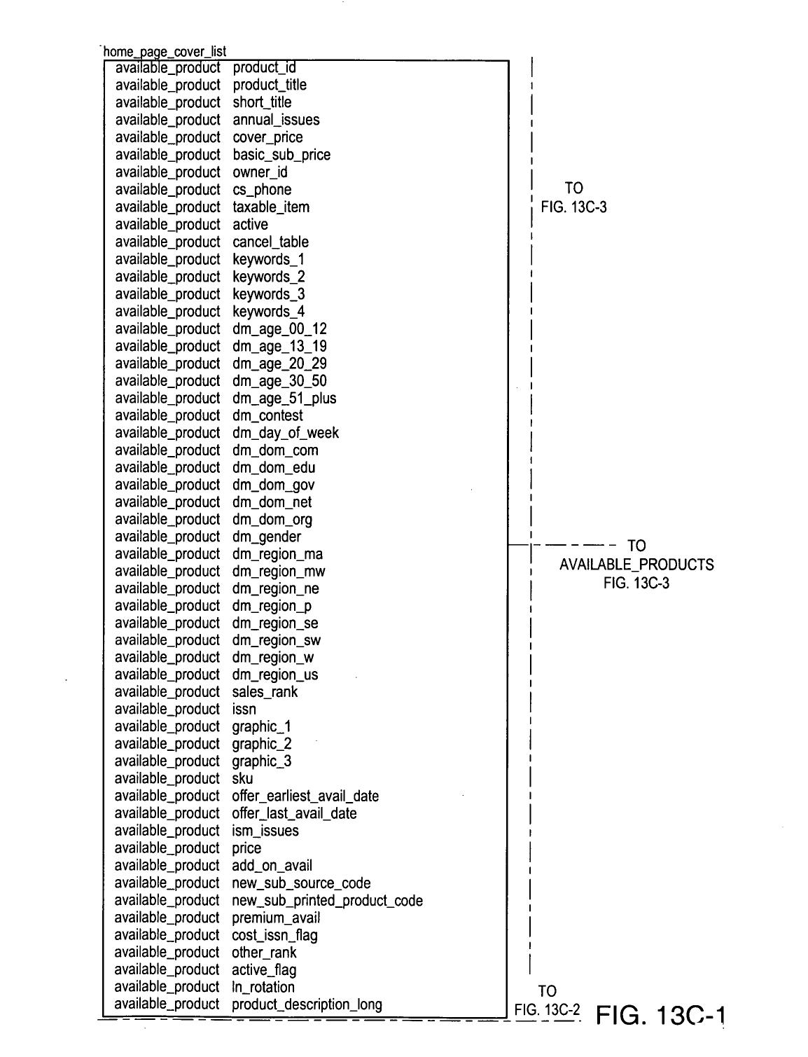

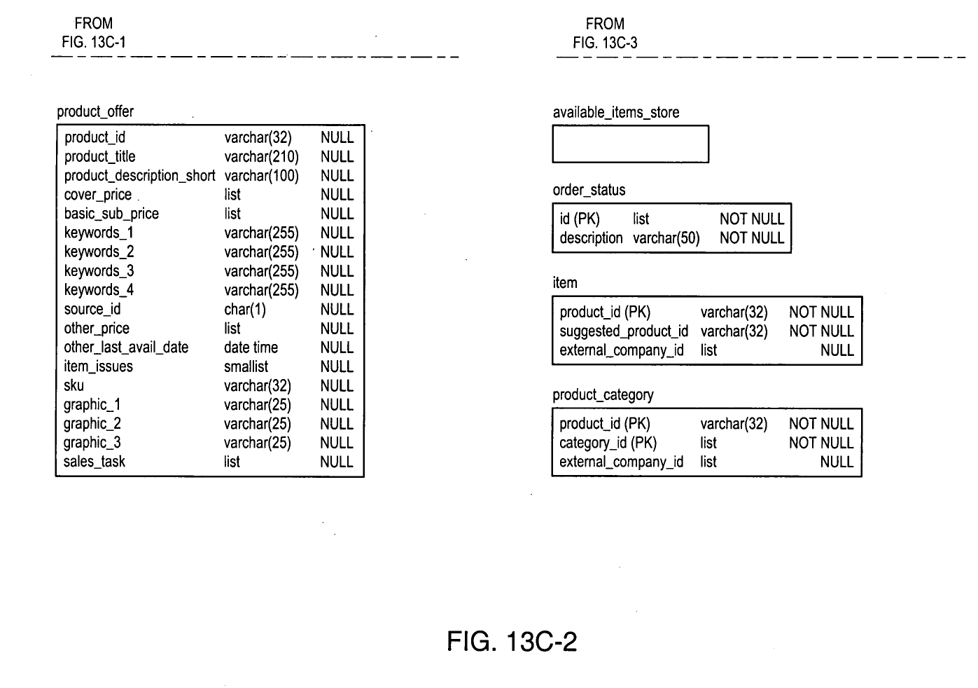

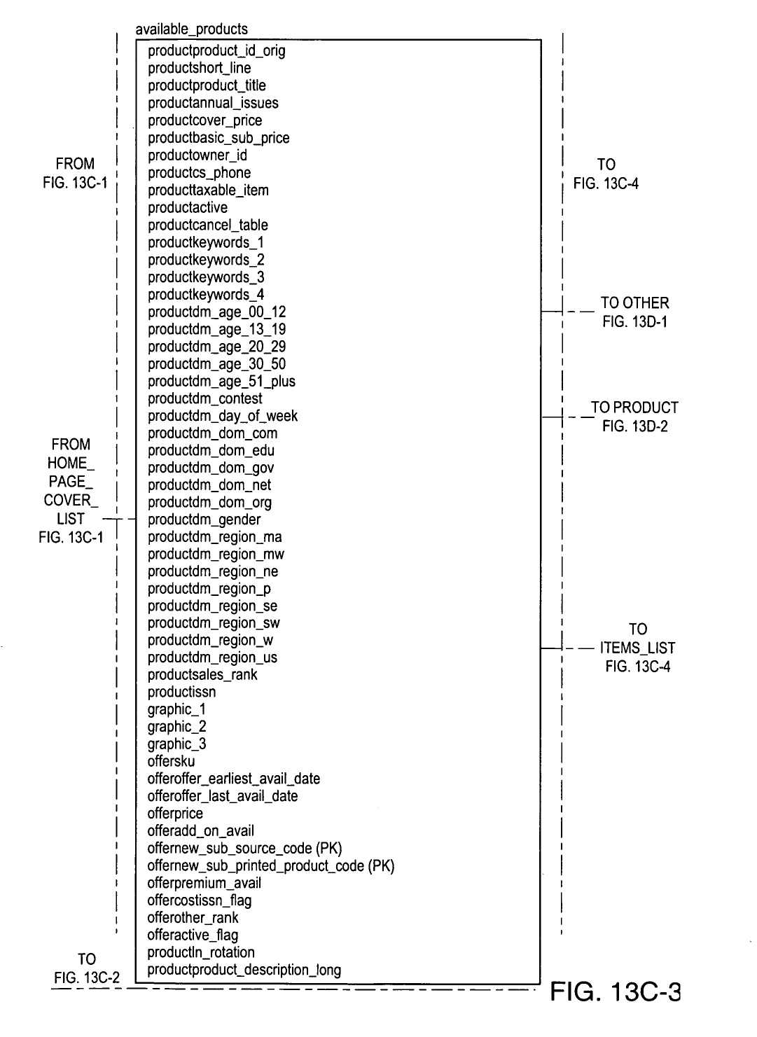

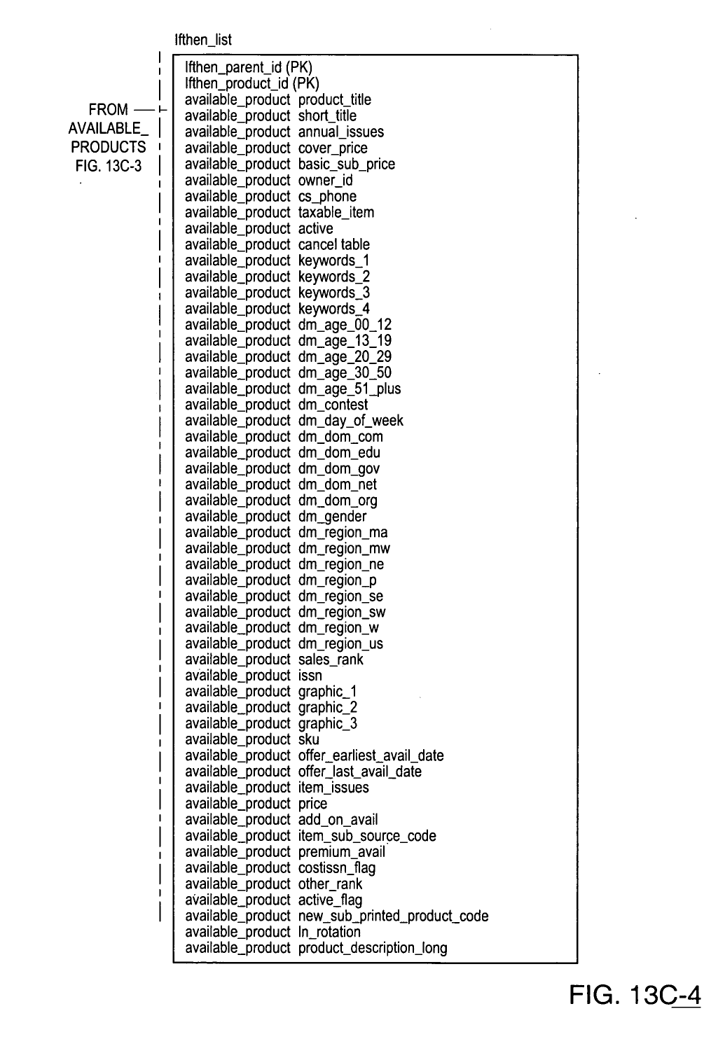

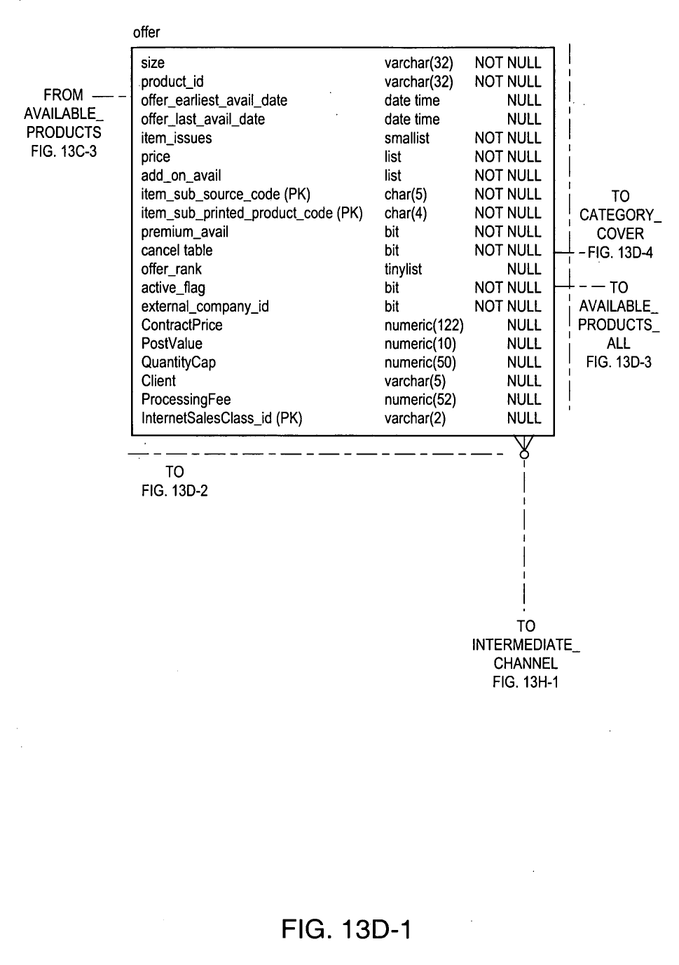

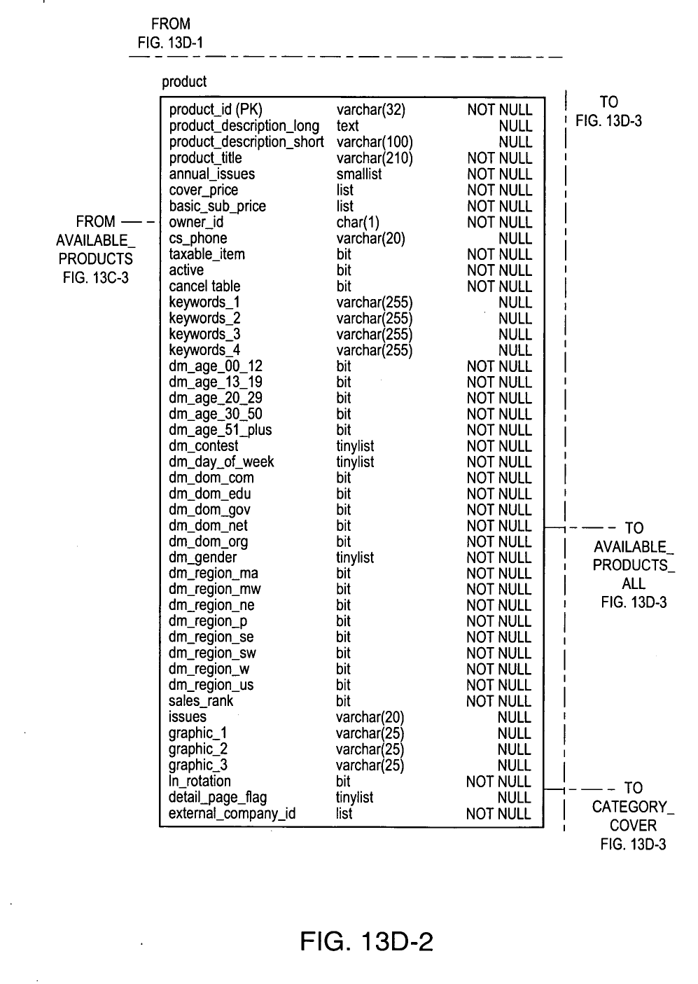

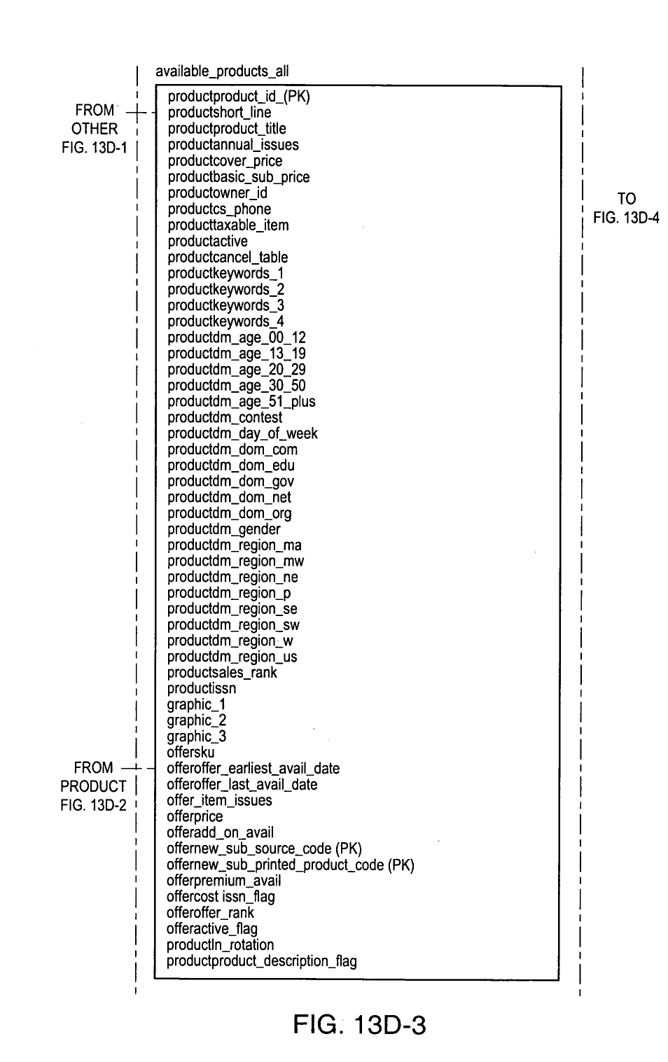

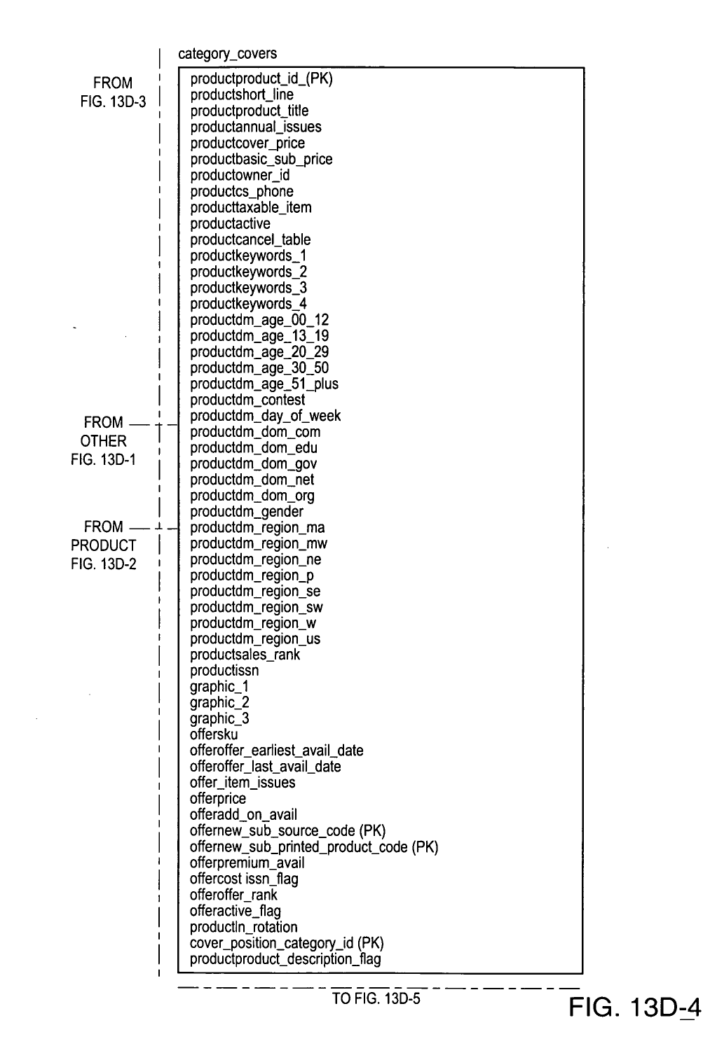

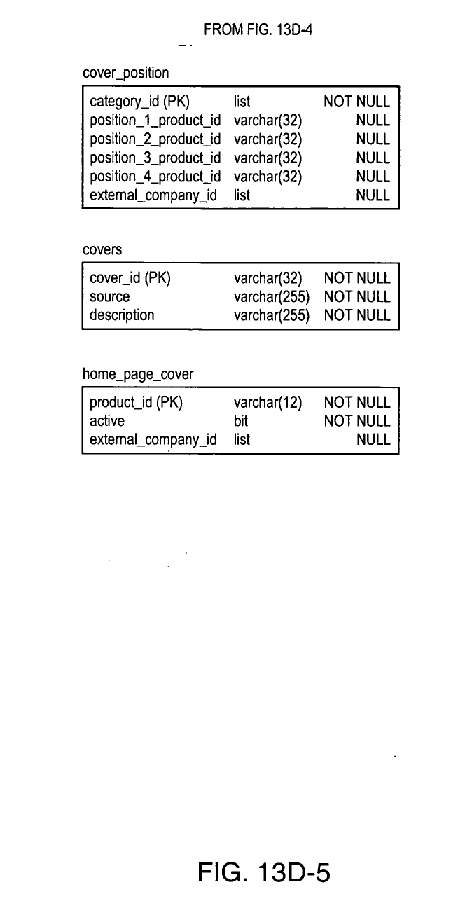

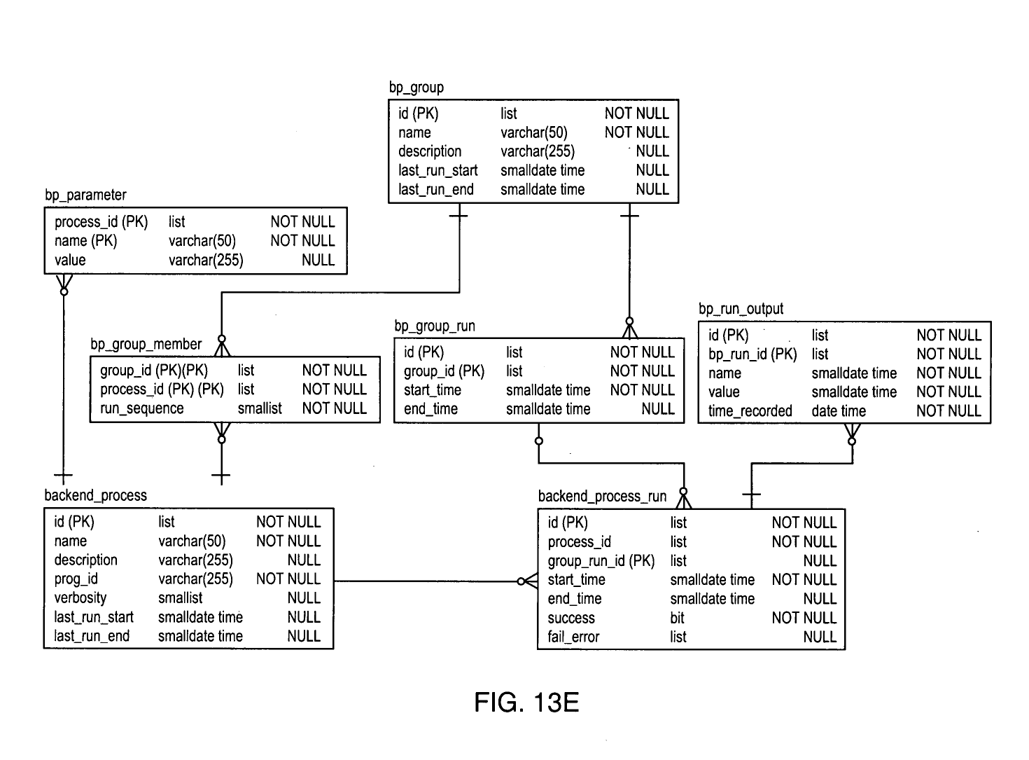

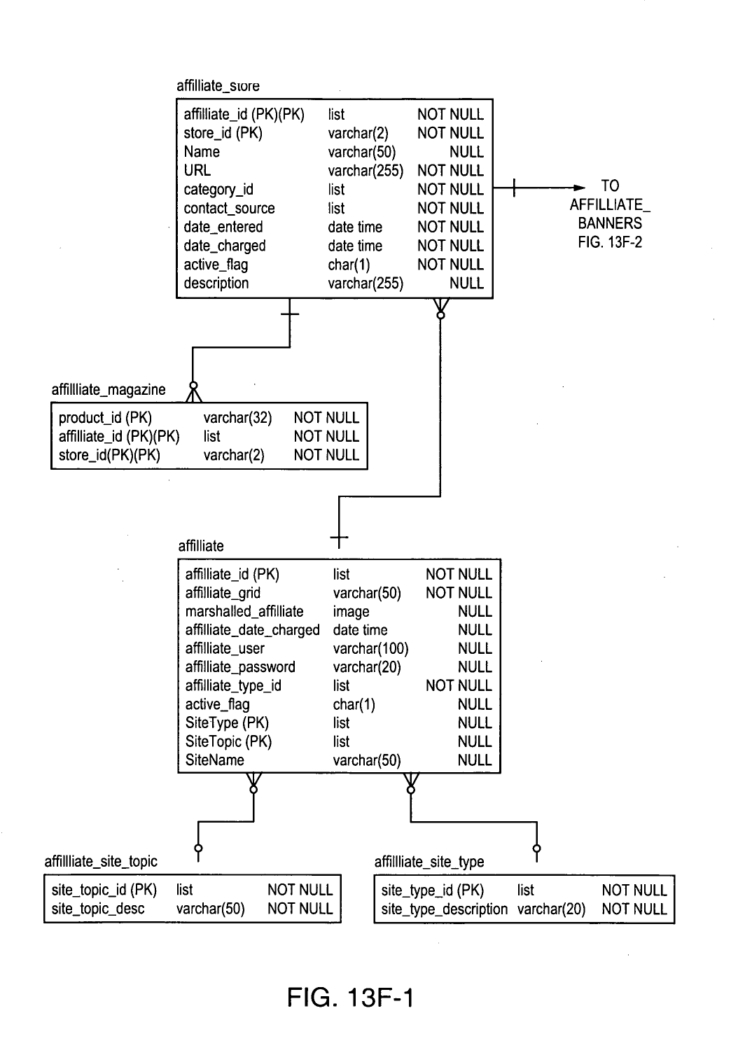

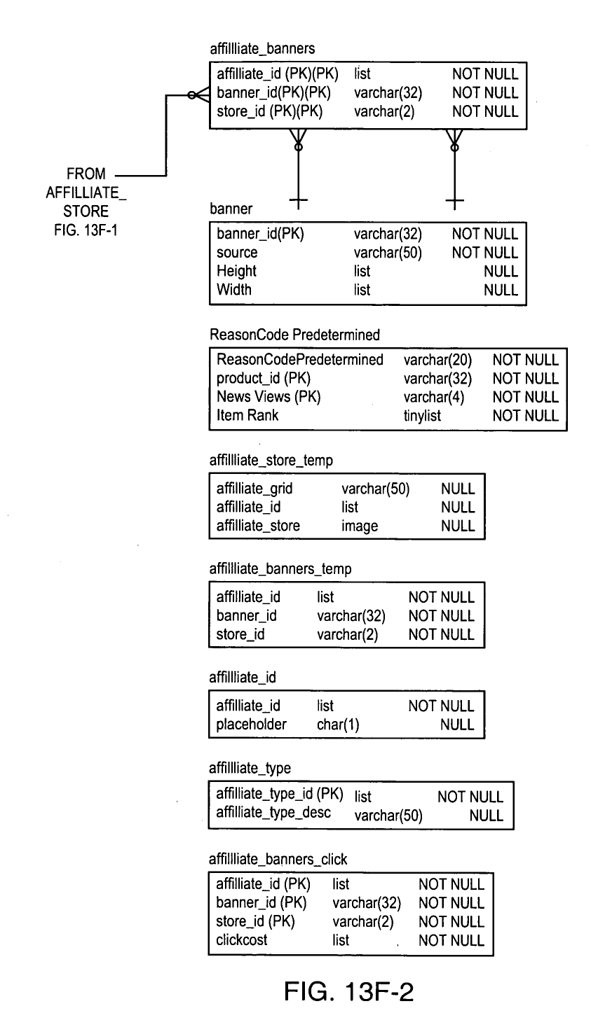

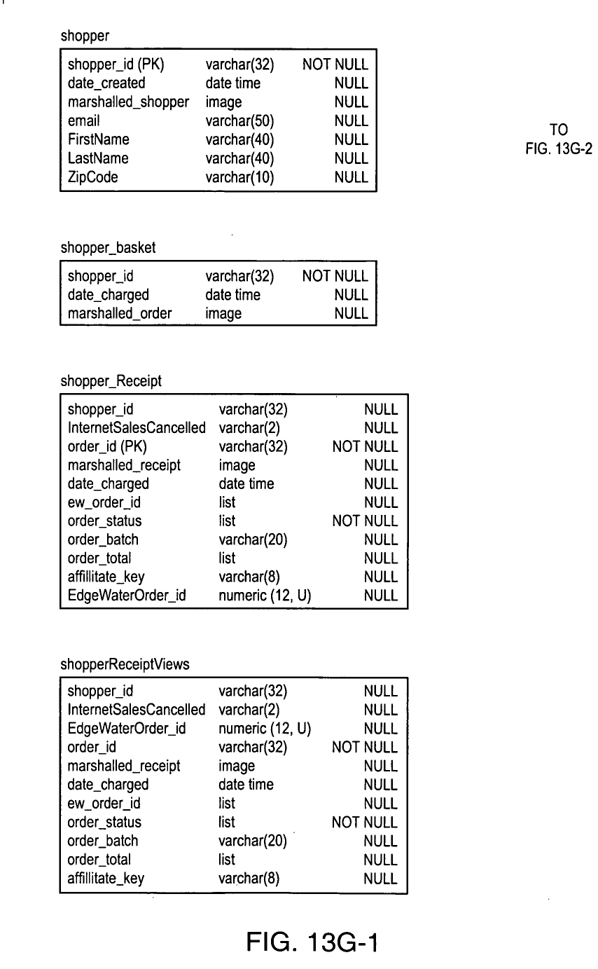

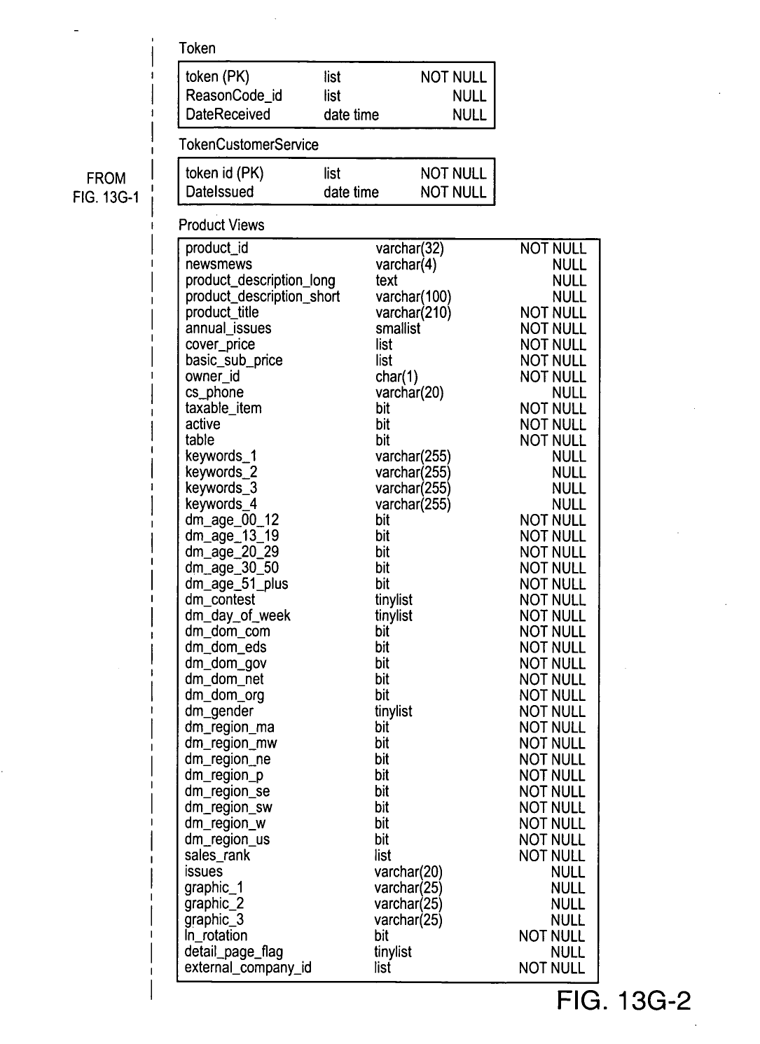

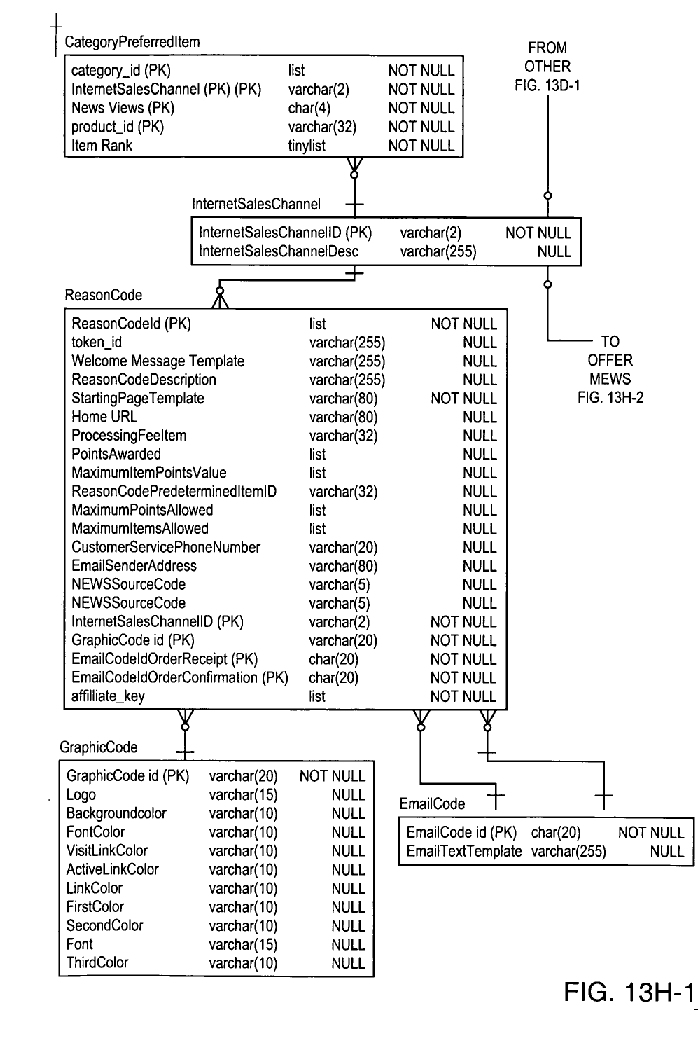

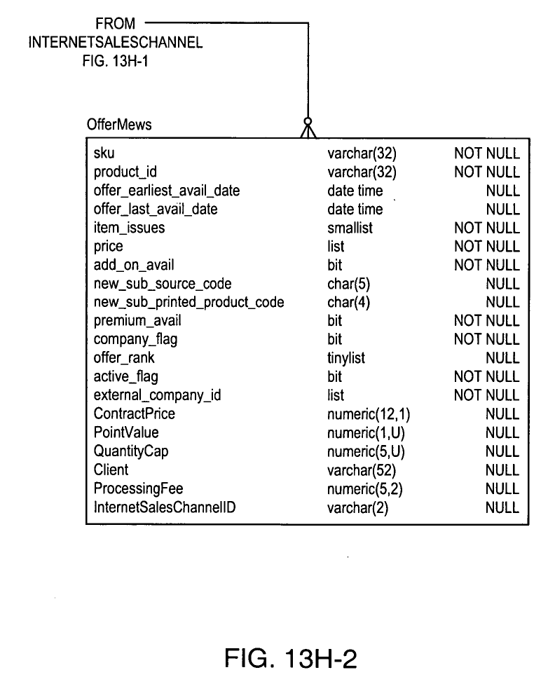

FIG. 13A-13H are an entity relation diagram (ERD) for creating a more commercially appropriate database configured for implementing an embodiment of the invention in an arrangement similar to the one of FIG. 5. As is understood in the art, the individual boxes are tabular representations of a record. Each table identifies its constituent fields and their data types. The items labeled “(PK)” are the primary keys. The lines connecting the boxes, represent the relationships between the tables connected by the line according to known database definition practice.

6. Additional Features

Although the invention has been described by way of a general linking of merchants and an application of the cross linking in the context of a reward program. The invention is also suitable for gift giving programs, where the customer can enter multiple addresses and specifies the shipping address of the recipients, for organizations to obtain donations, for frequent flyer type programs, etc. In other implementations, it may be useful to provide a direct link to a separate site to allow customers to, for example, purchase additional points for redemption, transfer points from another program, gift points to another individual or donate them to an organization.

In still other implementations, two merchants may link to each other, such that the excess inventory of one becomes the reward inventory of the other.

Similarly, the primary and/or secondary merchant may apply known market research methods to dynamically identify, on the basis of the customer's current and, if desired, past purchases, the best item(s) to include for a given reason code. This may be done by, for example, analyzing the category of merchant, category of products purchased, current activity of the customer at that site, SKU information for the sale of the original purchased product(s) or other behavioral factors. This is particularly helpful if a sale can be compound, involving several disparate types of items. Additionally, this assists the secondary merchant in offering a related group of disparate items. For example, in one instance, a purchaser of children's toys might receive an offer for a children's magazine. In another they might receive an offer for sports magazines because the toy purchase was a sports related toy.

In another example, a purchase of golf tees, a rain poncho, and a wool sport jacket, might be analyzed and result in an offer of Travel & Dining magazine, a discount voucher for hotel room near St. Andrews in Scotland, frequent flyer mileage and a pair of slacks from the Custom Trouser Shoppe. Moreover, if the SKU or behavioral information is dynamically made available to the secondary merchant for analysis, as part of the reason code, or as supplementary transferred data, the probability of a successful sale by the secondary merchant can be increased.

Similarly, it may be advantageous to use cookies to store additional information on the customer's computer or to provide periodic updates or reports to customers. Cookies allow for a more standardized method of obtaining desired information and customer tracking. Cookies may also be used in alternate implementations to further identify the customer for subsequent visits, allow for further customization of offers and/or to transfer data between merchants.

Independent of the particular system or method employed, in some embodiments, particularly those where a credit card number has been provided by the customer and the purchase or reward includes a commodity item normally available in a term-based subscription arrangement, it is possible and desirable to automatically convert the term-based subscription to an open-ended subscription such as described in incorporated U.S. patent application Ser. No. 08/762,007.

Additionally, for systems employing any type of rewards, it is also considered desirable to employ some form of anti-gaming procedures, where gaming is defined as activities intended to fool or circumvent the system logic into one or more of the following: providing additional rewards, improperly consolidating rewards, extending deadlines, allowing multiple orders, accepting invalid or fictitious credit card information, etc.

It should be understood that the above description is only representative of illustrative embodiments. For the reader's convenience, the above description has focused on a representative sample of all possible embodiments, a sample that teaches the principles of the invention. Other embodiments may result from a different combination of portions of different embodiments. The description has not attempted to exhaustively enumerate all possible variations. That alternate embodiments may not have been presented for a specific portion of the invention, may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent.

1-30. (canceled)

31. A method of facilitating online transactions based upon interactions between customers and merchants comprising:
providing by a first merchant online to a customer a plurality of incentives for completing a sales transaction with the first merchant;
determining an incentive selected by the customer in the sales transaction;
transmitting a reason code and a customer identifier from the first merchant to a second merchant indicating that the customer has completed the sales transaction with the first merchant, the reason code including an electronic address for communicating with the customer and information relating to the customer and to the incentive;
displaying, by the second merchant using the electronic address, an offer, to the customer graphically on-line, the offer selected according to the data associated with the reason code, the offer displayed while the customer is still connected to the first merchant;
receiving online by the second merchant an acceptance of the offer from the customer;
establishing by the second merchant an electronic communication connection with the first merchant;
sending from the second merchant to the first merchant the customer identifier;
sending, from the first merchant to the second merchant responsive to the customer identifier, customer payment information; and
processing by the second merchant the acceptance using the customer payment information.

32. The method of claim 31 further comprising:
decoding a data item to obtain the reason code and the customer identifier.

33. The method of claim 31 further comprising:
receiving by the second merchant SKU information from the first merchant; and
the second merchant assembling the offer based upon the SKU information.

34. The method of claim 33 further comprising:
receiving by the second merchant prioritization information from the first merchant for a compound purchase; and
the second merchant assembling offer components according to the prioritization information.

35-41. (canceled)

42. A system for facilitating online transactions based upon interactions between customers and merchants, comprising:
means for providing by a first merchant online to a customer a plurality of incentives an incentive for completing a sales transaction with the first merchant;
means for determining an incentive selected by the customer in the sales transaction;
means for transmitting a reason code and a customer identifier from the first merchant to a second merchant indicating that the customer has completed the sales transaction with the first merchant, the reason code including an electronic address for communicating with the customer and information relating to the customer and to the selected incentive;
means for displaying, by the second merchant using the electronic address, an offer to the customer, graphically on-line, the offer selected according to data associated with the reason code, the offer displayed while the customer is still connected to the first merchant;
means for receiving online by the second merchant an acceptance of the offer from the customer;
means for establishing by the second merchant an electronic communication connection with the first merchant;
means for sending from the second merchant to the first merchant the customer identifier;
means for sending from the second merchant to the first merchant the customer identifier;
means for sending from the first merchant to the second merchant responsive to the customer identifier, customer payment information; and
means for processing by the second merchant the acceptance using the customer payment information.

43. The system of claim 42 further comprising:
means for decoding a data item to obtain the reason code and the customer identifier.

44. The system of claim 42 further comprising:
means for receiving by the second merchant SKU information from the first merchant; and
means for the second merchant assembling the offer based upon the SKU information.

45. The system of claim 43 further comprising:
means for receiving by the second merchant prioritization information from the first merchant for a compound purchase; and
means for the second merchant assembling offer components according to the prioritization information.
